(19) United States
(12) Patent Application Publication
(10) Pub. No.: US 2025/0383503 A1
(43) Pub. Date: Dec. 18, 2025

(54) PHOTONIC INTEGRATED CIRCUIT AND METHODS OF FORMATION

(71) Applicant: Taiwan Semiconductor Manufacturing Company, Ltd., Hsinchu (TW)

(72) Inventors: Wen-Shun LO, Zhudong Township (TW); Tsung-Lin HSIEH, Hsinchu City (TW); Yi-Chia LEE, Yilan County (TW); Chun-Heng CHEN, Hsinchu City (TW); YingKit Felix TSUI, Cupertino, CA (US)

(21) Appl. No.: 18/743,373

(22) Filed: Jun. 14, 2024

(51) Int. Cl. G02B 6/27

(52) U.S. Cl. CPC G02B 6/2726

(57) ABSTRACT

A photonic integrated circuit may include a first waveguide that optically couples a second waveguide and a third waveguide. The first waveguide and the second waveguide are manufactured to have different sidewall angles. In particular, the first waveguide may be manufactured to have a greater sidewall angle than the second waveguide. The lesser sidewall angle of the second waveguide results in the second waveguide having a greater amount of sidewall taper, which enables a high gap-filling performance to be achieved around the second waveguide. The greater sidewall angle of the first waveguide results in the first waveguide having a lesser amount of sidewall taper (e.g., more vertical sidewalls), which provides a greater amount of surface area at the top of the first waveguide for coupling of input optical signals from the third coupler waveguide to the first waveguide.

### BACKGROUND

A photonic integrated circuit may include a polarization splitter and rotator (PSR) waveguide. The PSR waveguide may be used to receive an input optical signal and may split the input optical signal into two orthogonal polarized optical signals: a transverse electric (TE) polarized optical signal and a transverse magnetic (TM) polarized optical signal. The PSR waveguide then rotates one of the polarized optical signals such that two separated TE polarized optical signals or two separated TM polarized optical signal are provided as output from the PSR waveguide. PSR waveguides have various use cases, including wave division multiplexing (WDM) of input optical signals, mitigation of polarization-induced effects in input optical signals, and/or polarization-based sensing, among other examples.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1C are diagrams of an example of a photonic integrated circuit described herein.

FIGS. 2A-2QQ are diagrams of an example implementation of forming an example of a photonic integrated circuit described herein.

FIGS. 3A-3C are diagrams of an example of a photonic integrated circuit described herein.

FIGS. 4A-4L are diagrams of an example implementation of forming an example of a photonic integrated circuit described herein.

FIGS. 5A-5I are diagrams of an example implementation of forming an example of a photonic integrated circuit described herein.

FIG. 6 is a flowchart of an example process associated with forming a photonic integrated circuit described herein.

FIG. 7 is a flowchart of an example process associated with forming photonic integrated circuit described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a polarization splitter and rotator (PSR) waveguide of a photonic integrated circuit is optically coupled to an edge coupler waveguide by a coupling waveguide. The edge coupler waveguide enables input optical signals to be received, for example, from an external optical fiber and provided to the PSR waveguide through the coupling waveguide for signal processing.

The PSR waveguide may be manufactured to have a particular sidewall angle that facilitates a high gap-filling performance to be achieved when forming a dielectric layer over the PSR waveguide. The PSR waveguide and the coupling waveguide may be manufactured from the same semiconductor layer, and therefore the coupling waveguide may be manufactured to have the same sidewall angle of the PSR waveguide for efficient process integration and low process complexity for manufacturing the PSR waveguide and the coupling waveguide.

If the edge coupler waveguide is located in the dielectric layer above the coupling waveguide, input optical signals are coupled from the edge coupler waveguide to the coupling waveguide through a top of the coupling waveguide. The sidewall angle that is selected for the PSR waveguide to achieve a high gap-filling performance around the PSR waveguide may result in low optical coupling efficiency and increased optical signal loss in the coupling of input optical signals from the edge coupler waveguide to the coupling waveguide through a top of the coupling waveguide. In particular, the sidewall angle that is selected for the PSR waveguide may result in a high amount of taper in the sidewalls of the PSR waveguide to achieve a high gap-filling performance around the PSR waveguide, and the high amount of taper in the sidewalls in the coupling waveguide may result in a low amount of surface area in the top of the coupling waveguide through which input optical signals may be coupled from the edge coupler waveguide to the coupling waveguide.

In some implementations described herein, a photonic integrated circuit of a semiconductor device is manufactured to include a PSR waveguide, an edge coupler waveguide, and a coupling waveguide that optically couples the PSR waveguide and the edge coupler waveguide. The PSR waveguide and the coupling waveguide are manufactured to have different sidewall angles. In particular, the PSR waveguide may be manufactured to have a lesser sidewall angle than the coupling waveguide, and the coupling waveguide may be manufactured to have a greater sidewall angle than the PSR waveguide. The lesser sidewall angle of the sidewalls of the PSR waveguide results in the PSR waveguide having a greater amount of sidewall taper, which enables a high gap-filling performance to be achieved when forming a dielectric layer over the PSR waveguide. The greater sidewall angle of the sidewalls of the coupling waveguide results in the coupling waveguide having a lesser amount of sidewall taper (e.g., more vertical sidewalls), which provides a greater amount of surface area at the top of the coupling waveguide for increased coupling efficiency, and reduced optical signal loss for coupling of input optical signals from the edge coupler waveguide to the coupling waveguide.

The coupling waveguide may be manufactured such that only the portion of the coupling waveguide under the edge coupler waveguide has the greater sidewall angle, or may be manufactured such that a greater amount of the coupling waveguide has the greater sidewall angle, as described herein. The PSR waveguide and the coupling waveguide may be manufactured from the same semiconductor layer, using a sequence of masking and etching operations, which enables the process for forming the PSR waveguide and the coupling waveguide to be integrated with other complementary metal-oxide-semiconductor (CMOS) processes for the semiconductor device.

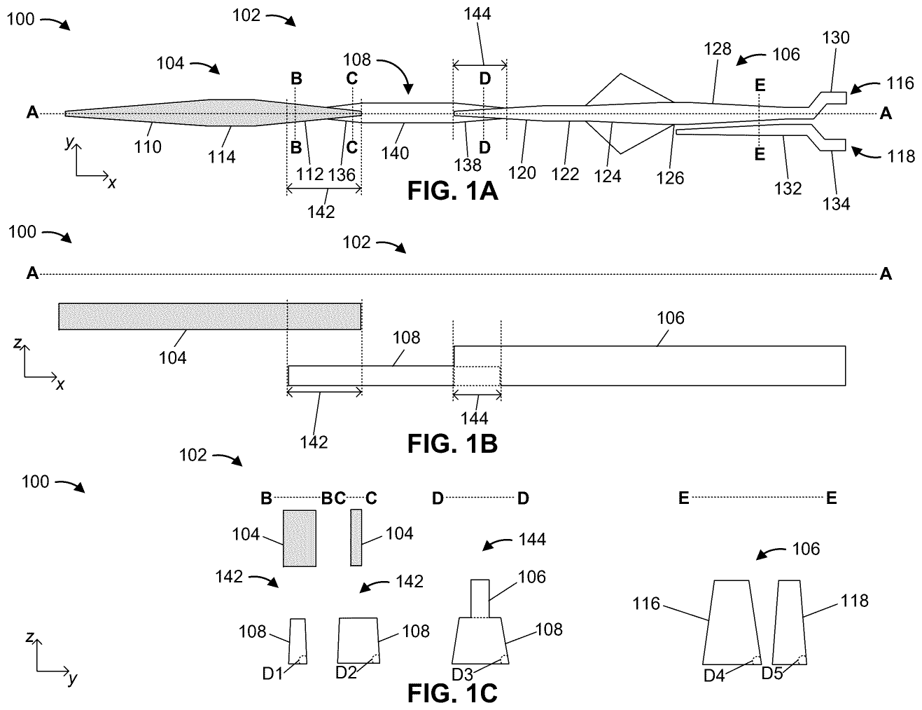

FIGS. 1A-1C are diagrams of an example 100 of a photonic integrated circuit 102 described herein. The photonic integrated circuit 102 may include an optical coupling circuit that includes an edge coupler waveguide 104, a PSR waveguide 106, and a coupling waveguide 108 that optically couples the edge coupler waveguide 104 and the PSR waveguide 106. In some implementations, the photonic integrated circuit 102 may be included in a semiconductor device, such as a semiconductor device 202 described herein.

FIG. 1A illustrates a top-down view of an x-y plane of the photonic integrated circuit 102. FIG. 1B illustrates a cross-sectional view of the photonic integrated circuit 102 along the line A-A in the x-direction in FIG. 1A. FIG. 1C illustrates a plurality of cross-section views in the y-direction in FIG. 1A, such as a cross-sectional view of the photonic integrated circuit 102 along the line B-B in FIG. 1A, a cross-sectional view of the photonic integrated circuit 102 along the line C-C in FIG. 1A, a cross-sectional view of the photonic integrated circuit 102 along the line D-D in FIG. 1A, and a cross-sectional view of the photonic integrated circuit 102 along the line E-E in FIG. 1A.

As shown in FIG. 1A, the edge coupler waveguide 104, the PSR waveguide 106, and the coupling waveguide 108 may each extend in the x-direction in the photonic integrated circuit 102. The edge coupler waveguide 104 may include a tapered section 110, a tapered section 112, and a transition section 114 between the tapered sections 110 and 112. The tapered section 110 may be optically coupled with an optical fiber, a fiber optic cable, and/or another type of external optical input. The edge coupler waveguide 104 may be configured to receive input optical signals from the external optical input and to provide the input optical signals to the coupling waveguide 108. Input optical signals may propagate through the edge coupler waveguide 104 in the x-direction.

As further shown in FIG. 1A, the PSR waveguide 106 may include a through segment 116 and a cross segment 118 that extends alongside the through segment 116 in the x-direction. The through segment 116 may include a tapered section 120, a transition section 122, a dual tapered section 124, a transition section 126, a tapered section 128, and/or an output section 130, among other examples. The through segment 116 may include different types of sections and/or a different arrangement of sections. The cross segment 118 may include a tapered section 132 and an output section 134.

The tapered section 120 of the through segment 116 of the PSR waveguide 106 may be optically coupled and physically coupled with the coupling waveguide 108 such that the input optical signals are received in the PSR waveguide 106 at the tapered section 120. An input optical signal (e.g., an unpolarized input optical signal) may propagate from the tapered section 120 through the transition section 122 and to the dual tapered section 124, where the input optical signal is split into a TE polarized optical signal and a TM polarized optical signal. Thus, the dual tapered section 124 may be referred to as the splitter section of the PSR waveguide 106.

The TE polarized optical signal and a TM polarized optical signal propagate through the tapered section 128, where either the TE polarized optical signal or the TM polarized optical signal is coupled to the tapered section 132 of the cross segment 118 and rotated. The optical signal that does not couple to the cross segment 118 continues to propagate through the output section 130 unmodified. For example, the TE polarized optical signal may couple from the tapered section 128 to the tapered section 132 and may be rotated in the cross segment 118 to become another TM polarized optical signal, whereas the TM polarized optical signal may remain in the through segment 116 and may propagate through to the output section 130. As another example, the TM polarized optical signal may couple from the tapered section 128 to the tapered section 132 and may be rotated in the cross segment 118 to become another TE polarized optical signal, whereas the TE polarized optical signal may remain in the through segment 116 and may propagate through to the output section 130.

As further shown in FIG. 1A, the coupling waveguide 108 may include a tapered section 136 at a first end of the coupling waveguide 108, a tapered section 138 at a second end of the coupling waveguide 108 opposing the first end, and a transition section 140 between the tapered sections 136 and 138. The coupling waveguide 108 may be located between the edge coupler waveguide 104 and the PSR waveguide 106 in the x-direction.

As shown in FIGS. 1A and 1B the edge coupler waveguide 104 and the coupling waveguide 108 at least partially overlap in a coupling region 142 of the photonic integrated circuit 102. In the coupling region 142, the tapered section 136 at the first end of the coupling waveguide 108 may be at least partially overlapped by the tapered section 112 at an end of the edge coupler waveguide 104 opposing the end of the edge coupler waveguide 104 to which the edge coupler waveguide 104 is optically coupled to the external optical input. The coupling region 142 is where input optical signals transition between the edge coupler waveguide 104 and the coupling waveguide 108.

As further shown in FIGS. 1A and 1B, the PSR waveguide 106 and the coupling waveguide 108 at least partially overlap in another coupling region 144 of the photonic integrated circuit 102. In the coupling region 144, the tapered section 138 at the second end of the coupling waveguide 108 may be at least partially overlapped by the tapered section 120 at an end of the PSR waveguide 106, opposing the end of the PSR waveguide 106 at which the output sections 130 and 134 are located. The coupling region 144 is where input optical signals transition between the PSR waveguide 106 and the coupling waveguide 108.

As shown in FIG. 1B, the edge coupler waveguide 104 may be located at a greater height or greater vertical (z-direction) position in the photonic integrated circuit 102 than the PSR waveguide 106 and the coupling waveguide 108, because the edge coupler waveguide 104 is formed in a dielectric layer that is above the PSR waveguide 106 and the coupling waveguide 108. The edge coupler waveguide 104 may include a dielectric waveguide that includes one or more dielectric materials, whereas the PSR waveguide 106 and the coupling waveguide 108 may each include a semiconductor waveguide that includes one or more semiconductor materials. Examples of dielectric materials that may be included in the edge coupler waveguide 104 include silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples. Examples of semiconductor materials that may be included in the PSR waveguide 106 and in the coupling waveguide 108 include silicon (Si), germanium (Ge), and/or another semiconductor material.

The greater vertical position of the edge coupler waveguide 104 results in the tapered section 112 of the edge coupler waveguide 104 being located above and/or over the tapered section 136 of the coupling waveguide 108 in the coupling region 142. The tapered section 112 of the edge coupler waveguide 104 and the tapered section 136 of the coupling waveguide 108 may be spaced apart in the z-direction in the coupling region 142 such that the edge coupler waveguide 104 and the coupling waveguide 108 are not in physical contact. Input optical signals may propagate downward in the z-direction from the edge coupler waveguide 104 to the coupling waveguide 108 in the coupling region 142.

As further shown in FIG. 1B, the bottom surfaces of the PSR waveguide 106 and the coupling waveguide 108 may be located at approximately a same height or vertical (z-direction) position in the photonic integrated circuit 102 because of the PSR waveguide 106 and the coupling waveguide 108 being formed from the same semiconductor layer. However, as shown in FIG. 1B, the PSR waveguide 106 may have a greater vertical (z-direction) thickness than the coupling waveguide 108. The tapered section 138 of the coupling waveguide 108 and the tapered section 120 of the PSR waveguide 106 may be physically coupled (e.g., may be in direct physical contact), as well as optically coupled, in the coupling region 144. Input optical signals may propagate upward in the z-direction from the coupling waveguide 108 to the PSR waveguide 106 in the coupling region 144.

As shown in FIG. 1C, the edge coupler waveguide 104, the PSR waveguide 106, and the coupling waveguide 108 may each include a strip waveguide cross-sectional profile, except in the coupling region 144 where the combination of the PSR waveguide 106 and coupling waveguide 108 corresponds to a slab waveguide cross-sectional profile. The slab waveguide cross-sectional profile occurs due to the PSR waveguide 106 being located on top of (and in physical contact with) the coupling waveguide 108 in the coupling region 144, as shown in the C-C cross-section in FIG. 1C.

As further shown in FIG. 1C, the cross-sectional width of the edge coupler waveguide 104 in the y-direction is greater than the cross-sectional width of the coupling waveguide 108 in the y-direction at the location of the B-B cross-section, whereas the cross-sectional width of the edge coupler waveguide 104 in the y-direction is less than the cross-sectional width of the coupling waveguide 108 in the y-direction at the location of the B-B cross-section. This occurs due to the cross-sectional width of the edge coupler waveguide 104 and the cross-sectional width of the coupling waveguide 108 decreasing in opposite directions along the x-direction in the coupling region 142.

As further shown in FIG. 1C, the tapered section 136 of the coupling waveguide 108 may have a sidewall angle (indicated in FIG. 1C as dimension D1) at the location of the B-B cross-section in the coupling region 142. The tapered section 136 of the coupling waveguide 108 may have another sidewall angle (indicated in FIG. 1C as dimension D2) at the location of the C-C cross-section in the coupling region 142. The tapered section 138 of the coupling waveguide 108 may have a sidewall angle (indicated in FIG. 1C as dimension D3) at the location of the D-D cross-section in the coupling region 144. The tapered section 128 of the PSR waveguide 106 may have a sidewall angle (indicated in FIG. 1C as dimension D4) at the location of the E-E cross-section (e.g., in the coupling region between the through segment 116 and the cross segment 118 of the PSR waveguide 106). The tapered section 132 of the PSR waveguide 106 may have a sidewall angle (indicated in FIG. 1C as dimension D5) at the location of the E-E cross-section (e.g., in the coupling region between the through segment 116 and the cross segment 118 of the PSR waveguide 106).

The sidewall angles described herein refer to a y-direction angle between a bottom surface of a waveguide and a sidewall of the waveguide. Thus, lesser sidewall angles result in a greater amount of taper in the z-direction between opposing sidewalls, meaning that the sidewalls in the y-direction converge from a bottom of the waveguide to a top of a waveguide at a greater rate than the rate of convergence for greater sidewall angles.

The PSR waveguide 106 and the coupling waveguide 108 may be manufactured from the semiconductor layer, using techniques described herein, such that one or more sections of the coupling waveguide 108 have a different sidewall angle in the y-direction than the PSR waveguide 106. For example, the coupling waveguide 108 may be manufactured such that the tapered section 136 in the coupling region 142 has a greater sidewall angle than the PSR waveguide. In other words, the coupling waveguide 108 may be manufactured such that the dimension D1 and the dimension D2 are greater than the dimension D4 and the dimension D5. Conversely, the PSR waveguide 106 may be manufactured to have a lesser sidewall angle than the tapered section 136 of the coupling waveguide 108. In other words, the PSR waveguide 106 may be manufactured such that the dimension D4 and the dimension D5 are less than the dimension D1 and the dimension D2.

The greater sidewall angles of the tapered section 136 of the coupling waveguide 108 results in the tapered section 136 of the coupling waveguide 108 has a lesser amount of sidewall taper and, thus, more vertical sidewalls. The greater verticality of the sidewalls of the tapered section 136 of the coupling waveguide 108 provides a greater amount of surface area at the top of the coupling waveguide 108 in the coupling region 142, which provides a greater amount of surface area for input optical signals to propagate from the edge coupler waveguide 104 to the coupling waveguide 108 in the coupling region 142. This enables a high coupling efficiency and a low amount of optical signal loss to be achieved for coupling of input optical signals from the edge coupler waveguide 104 to the coupling waveguide 108 in the coupling region 142.

The lesser sidewall angle of the sidewalls of the PSR waveguide 106 results in the PSR waveguide 106 having a greater amount of sidewall taper. The greater amount of sidewall taper in the sidewalls of the PSR waveguide 106 enables dielectric material to more easily be deposited around sidewalls of the PSR waveguide 106, particularly in locations between the tapered section 128 of the through segment 116 and the tapered section 132 of the cross segment 118. This enables a high gap-filling performance to be achieved when forming a dielectric layer over the PSR waveguide 106.

In some implementations, the dimension D1 and the dimension D2 may each be included in a range of approximately 86 degrees to approximately 88 degrees, to achieve a high coupling efficiency and a low amount of optical signal loss to be achieved for coupling of input optical signals from the edge coupler waveguide 104 to the coupling waveguide 108 in the coupling region 142. However, other values and ranges for the dimension D1 and the dimension D2 are within the scope of the present disclosure. In some implementations, the dimension D4 and the dimension D5 may each be included in a range of approximately 80 degrees to approximately 85 degrees, to achieve a high gap-filling performance for forming a dielectric layer over the PSR waveguide 106. However, other values and ranges for the dimension D4 and the dimension D5 are within the scope of the present disclosure.

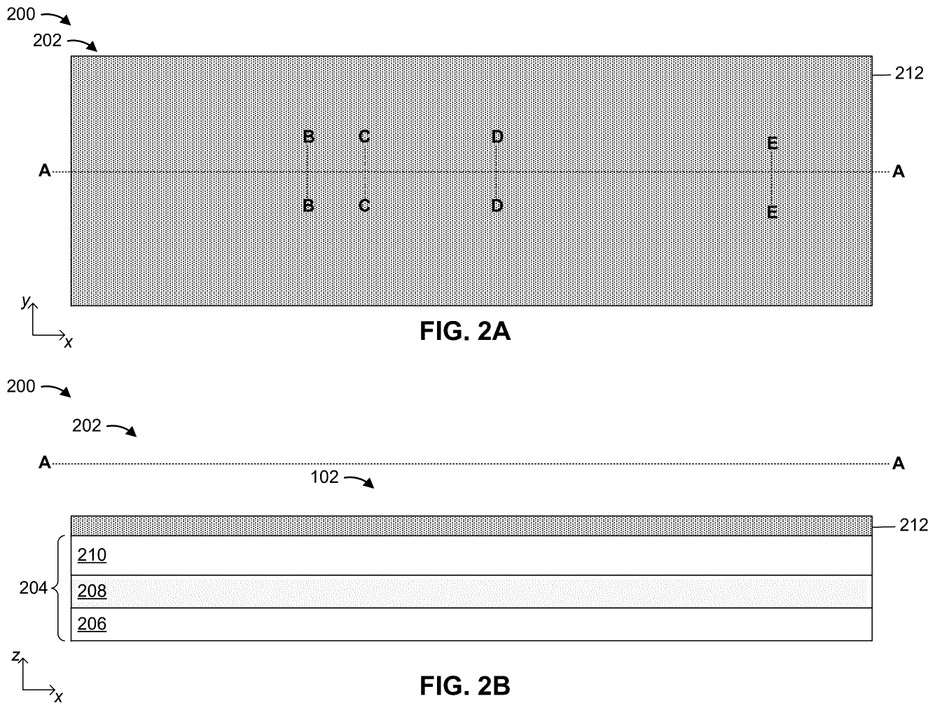

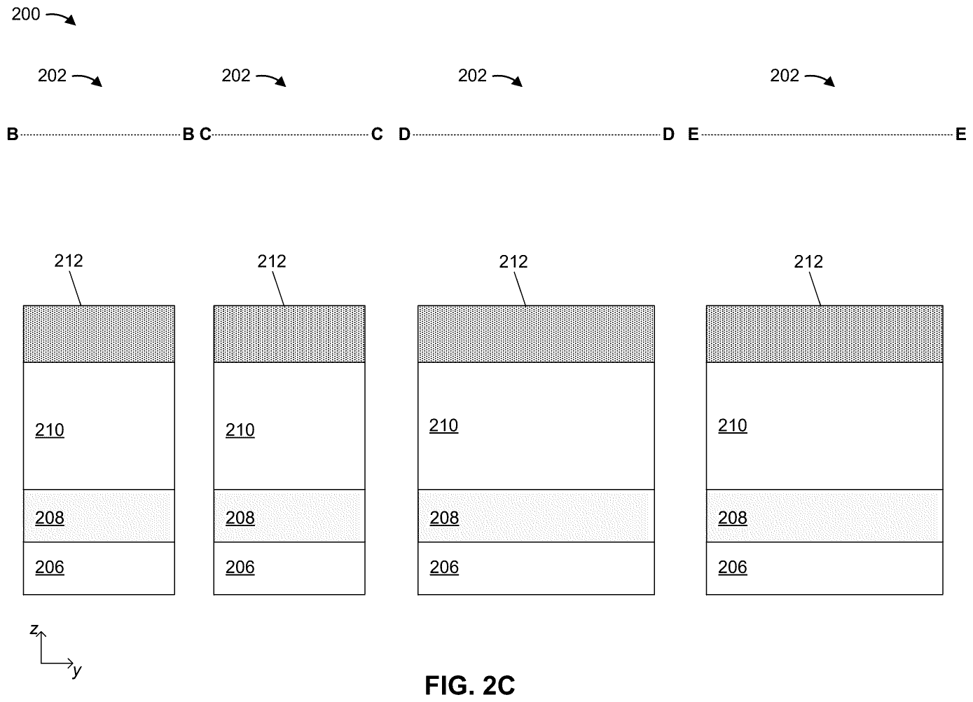

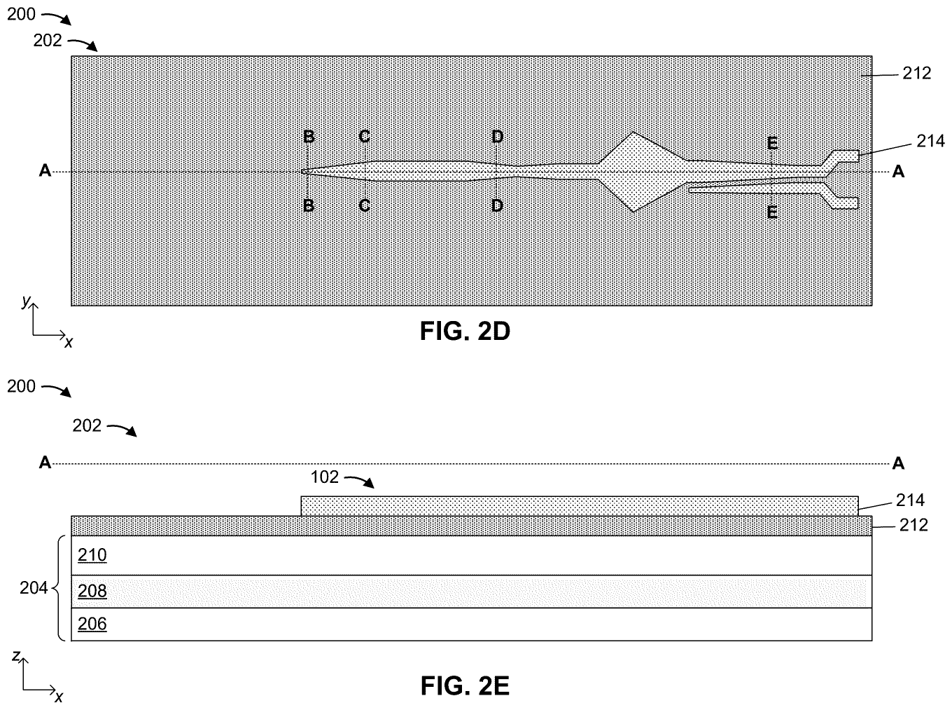

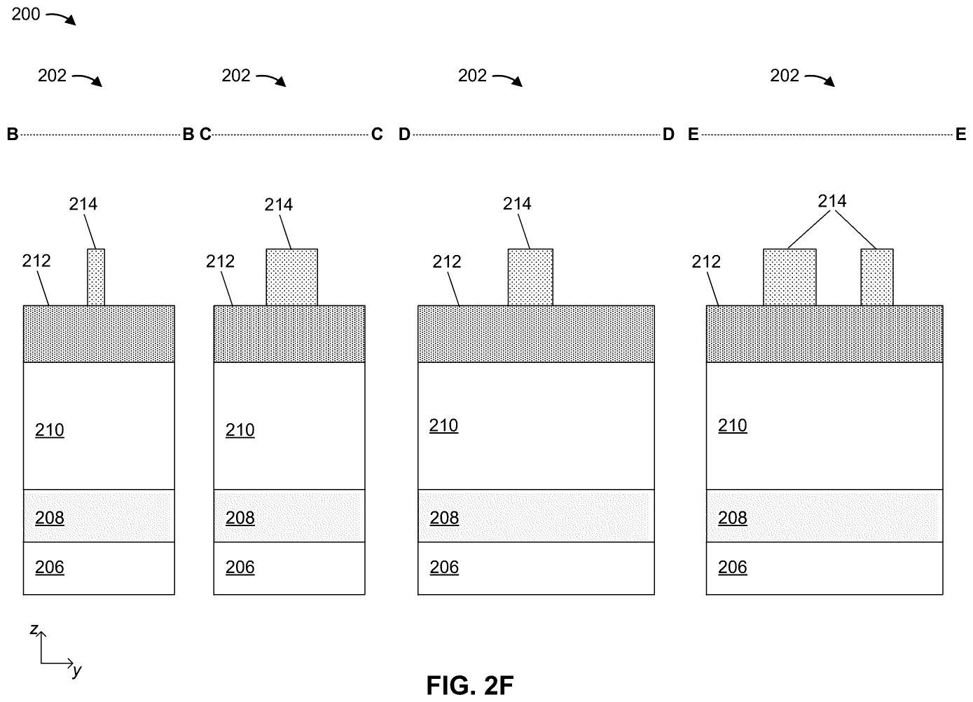

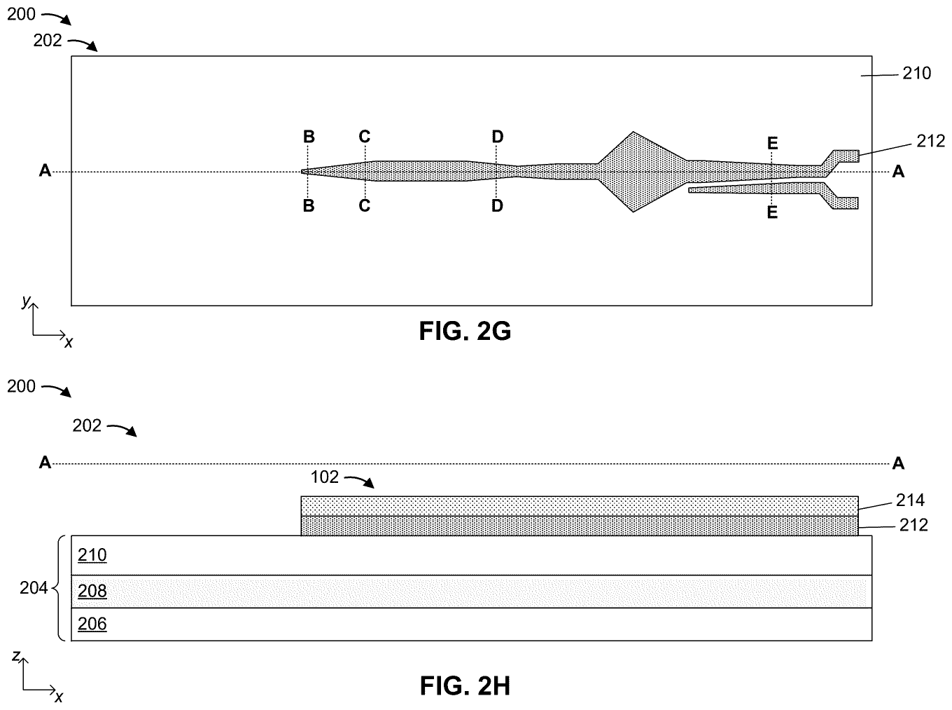

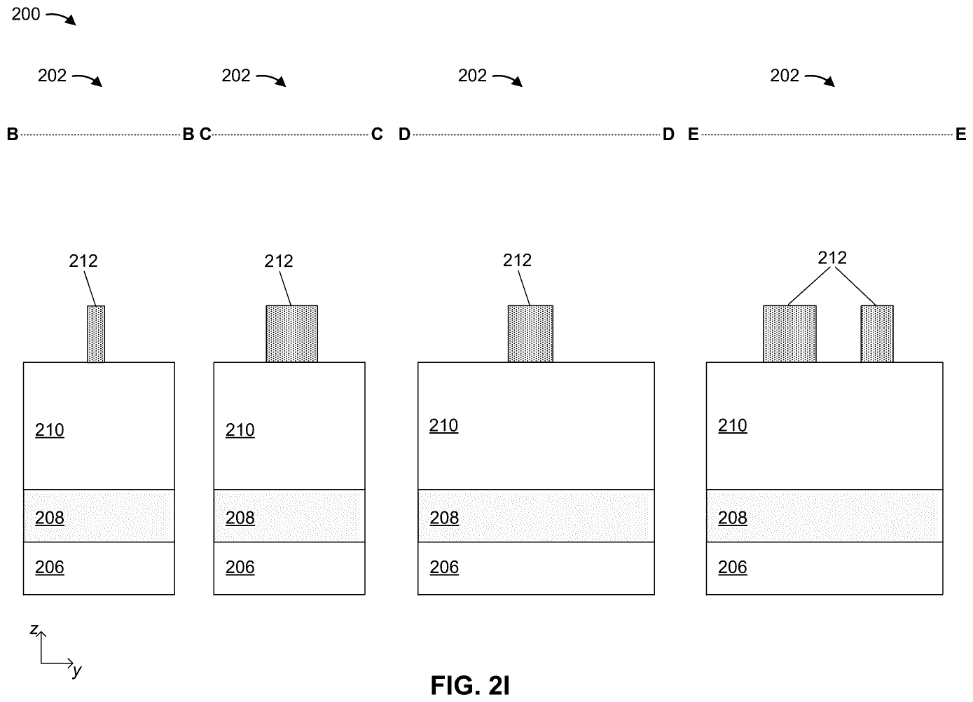

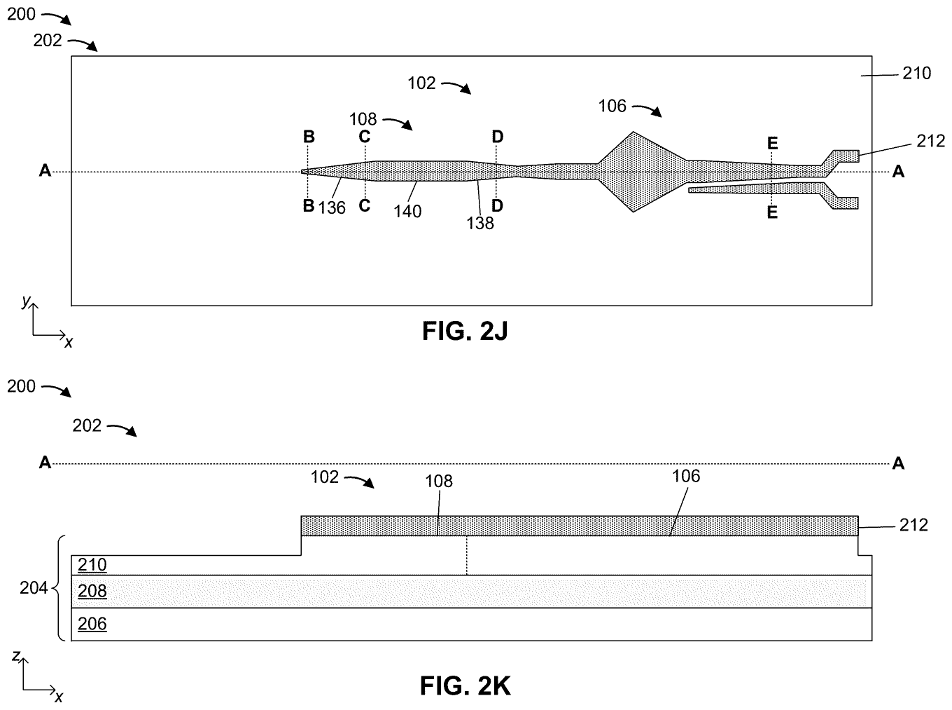

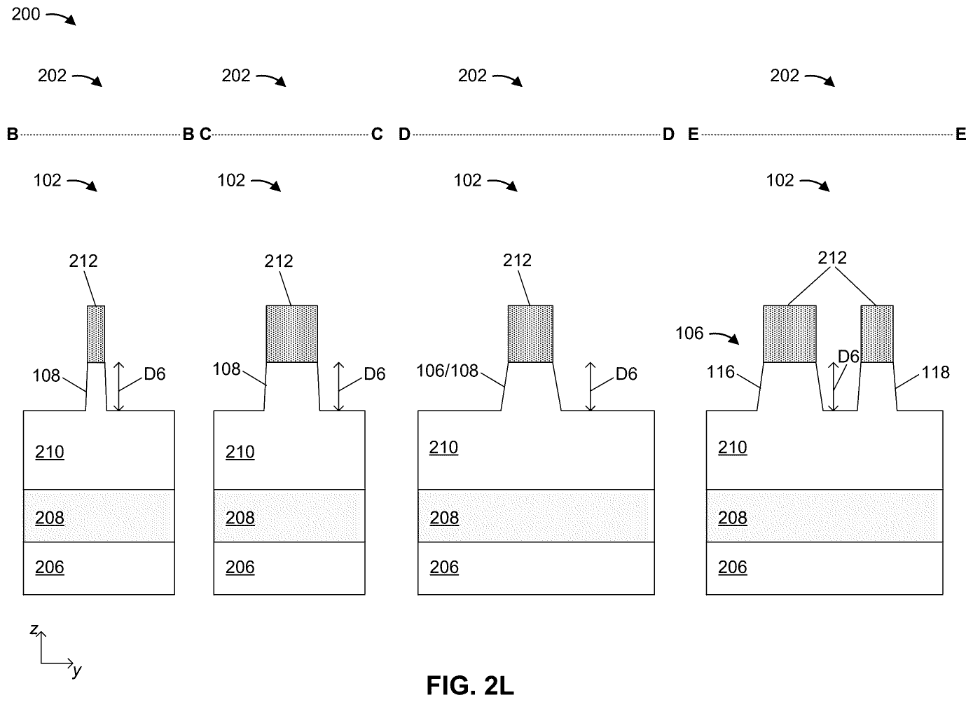

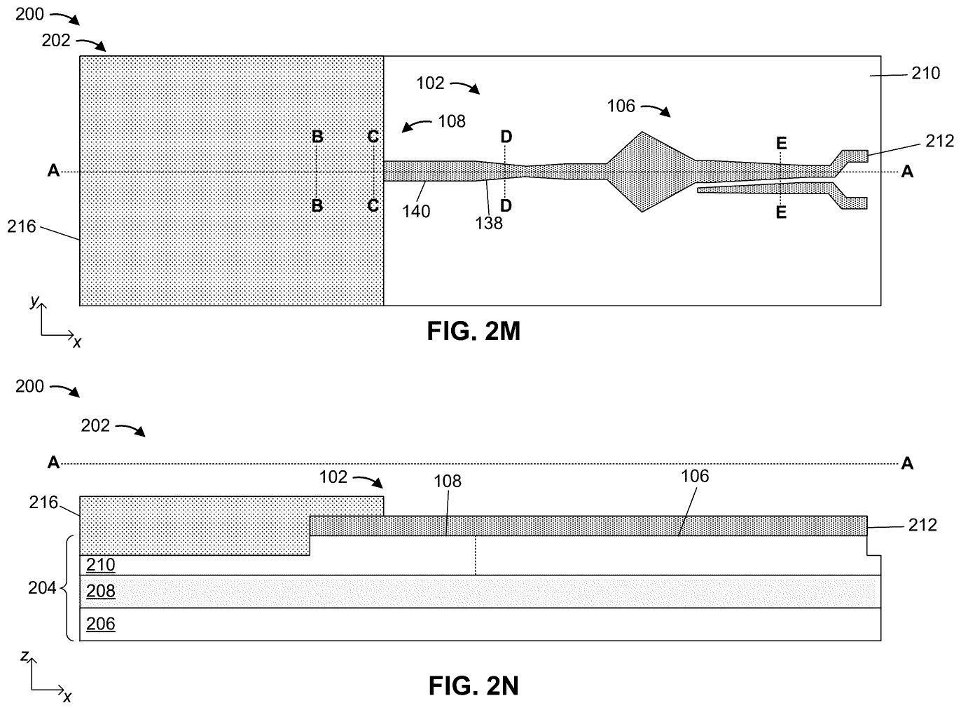

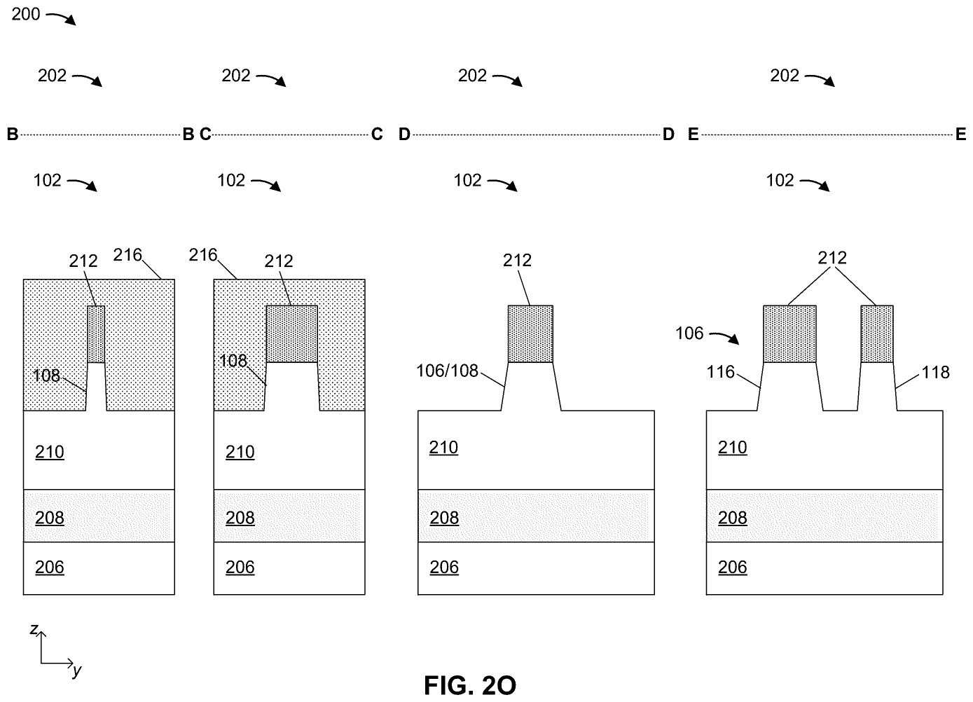

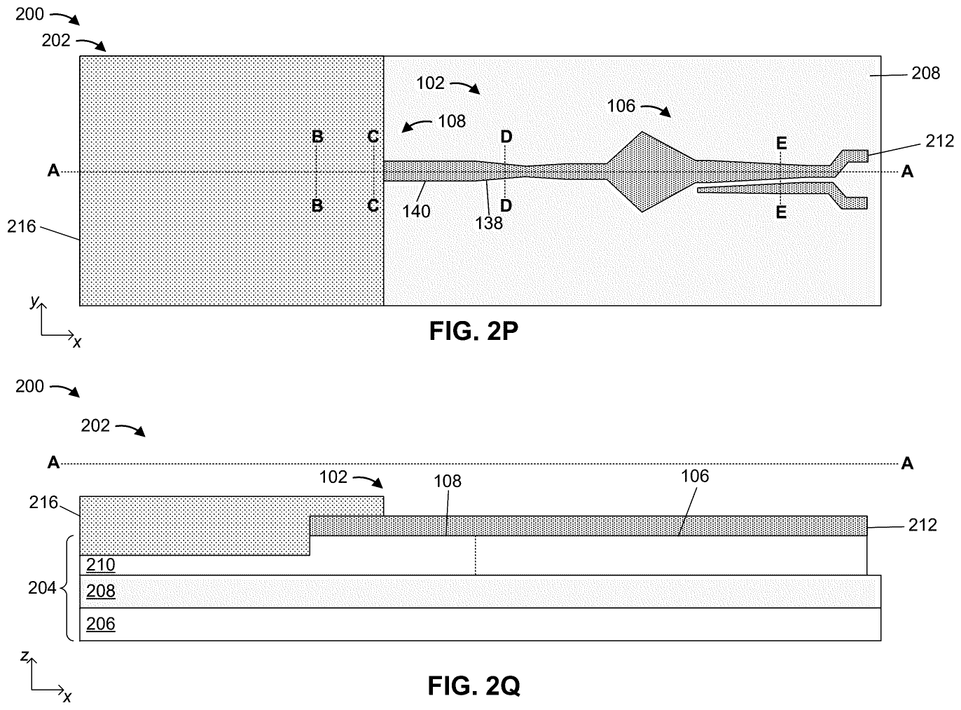

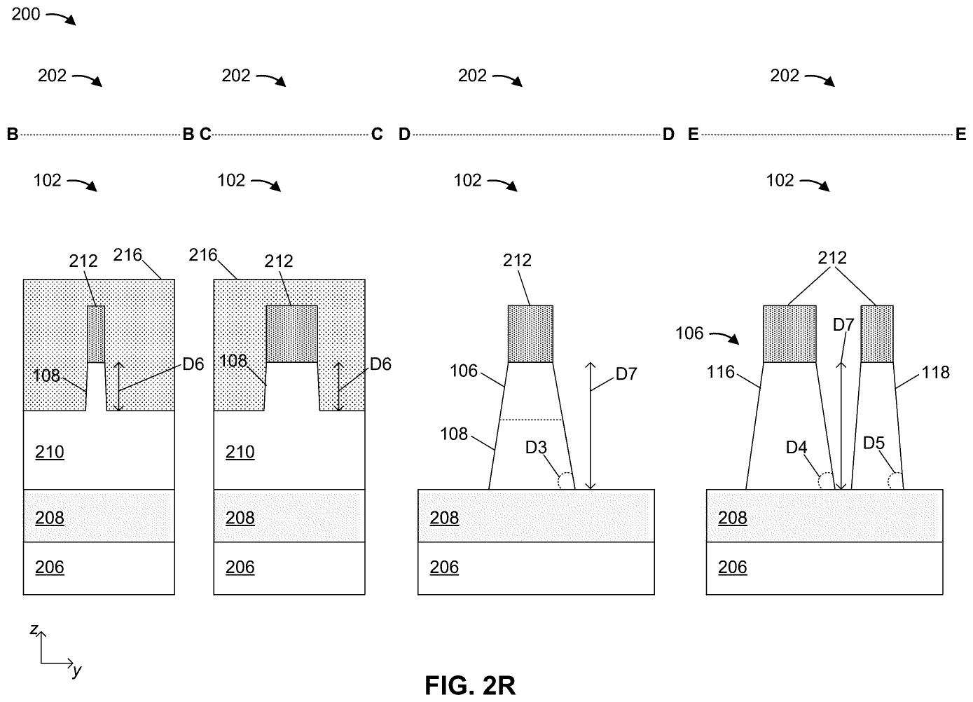

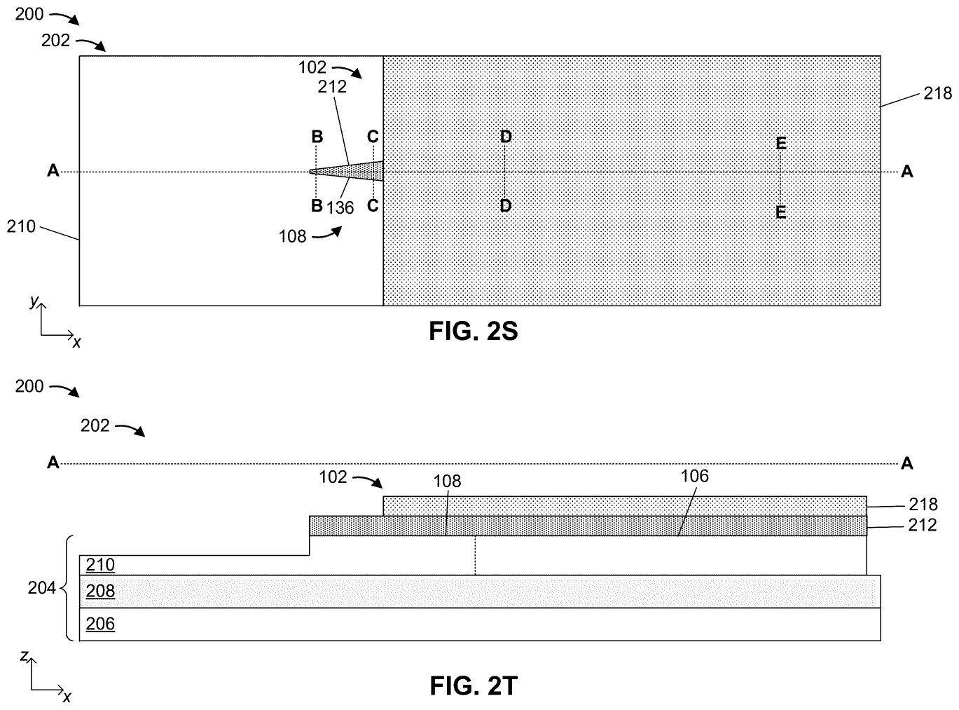

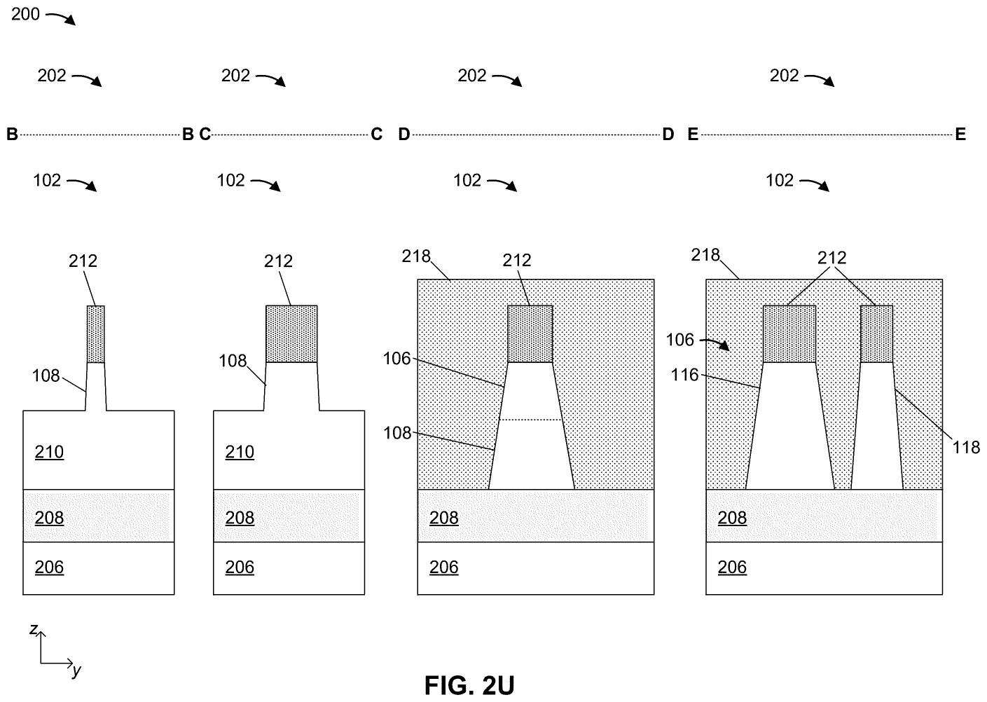

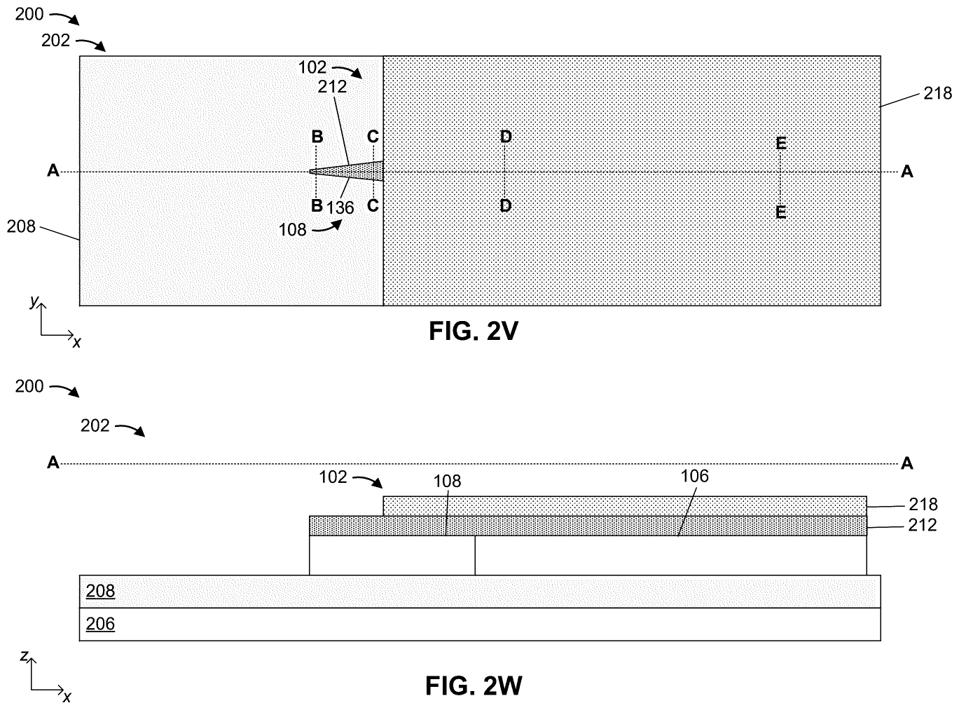

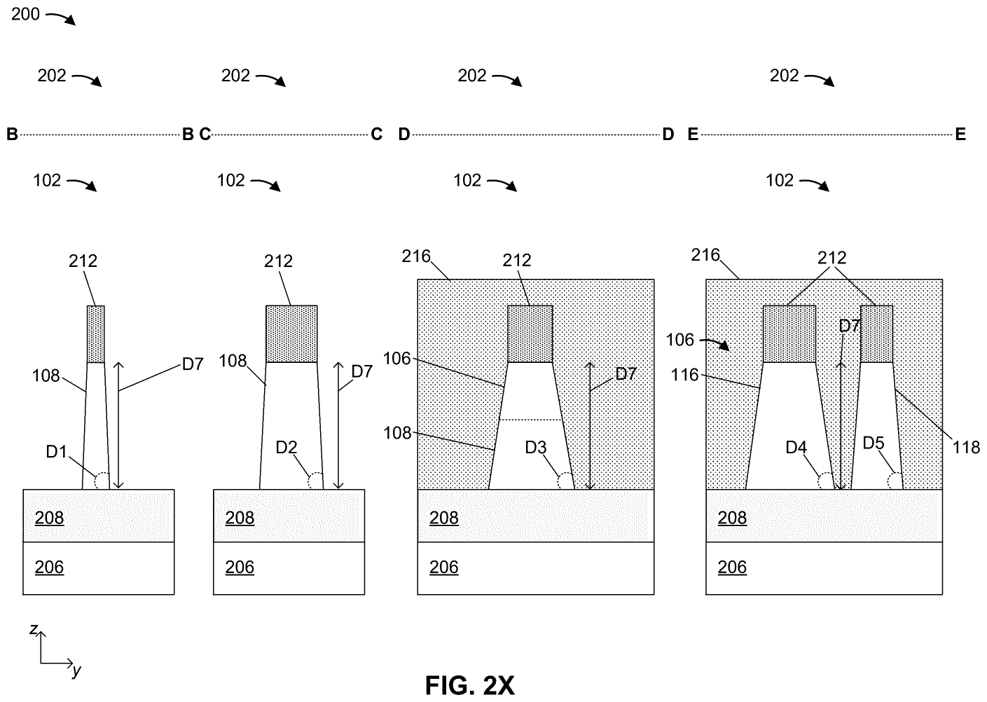

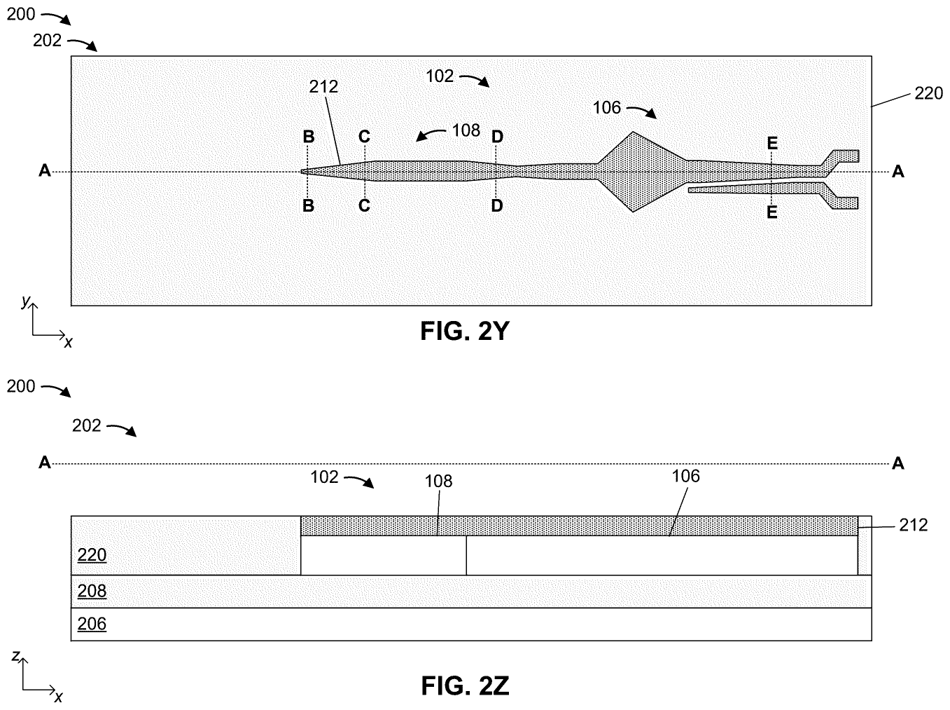

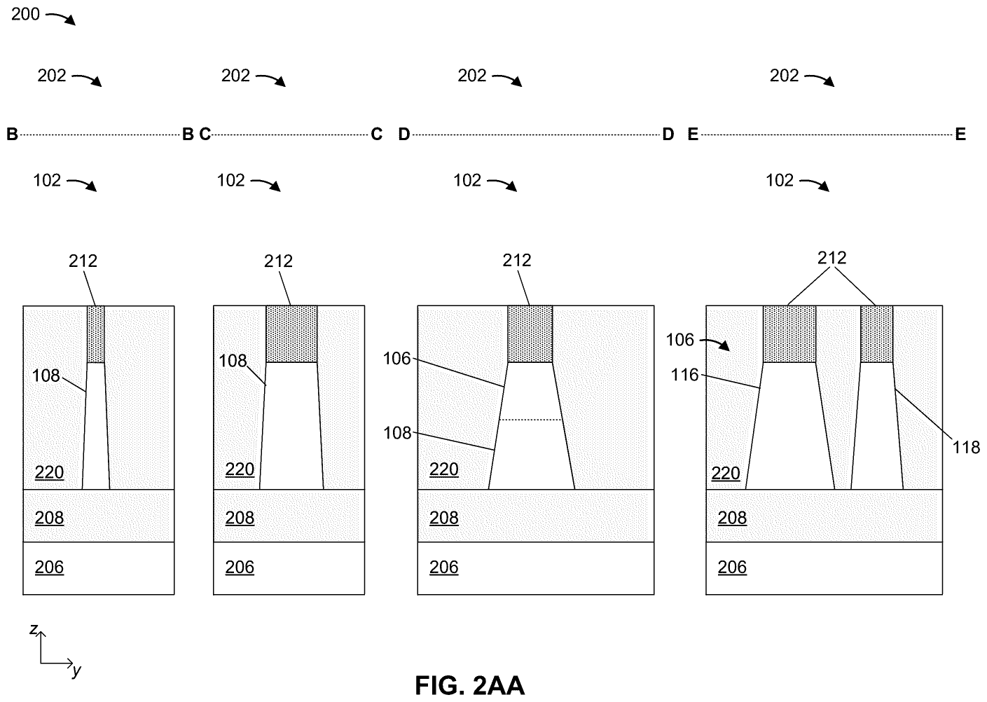

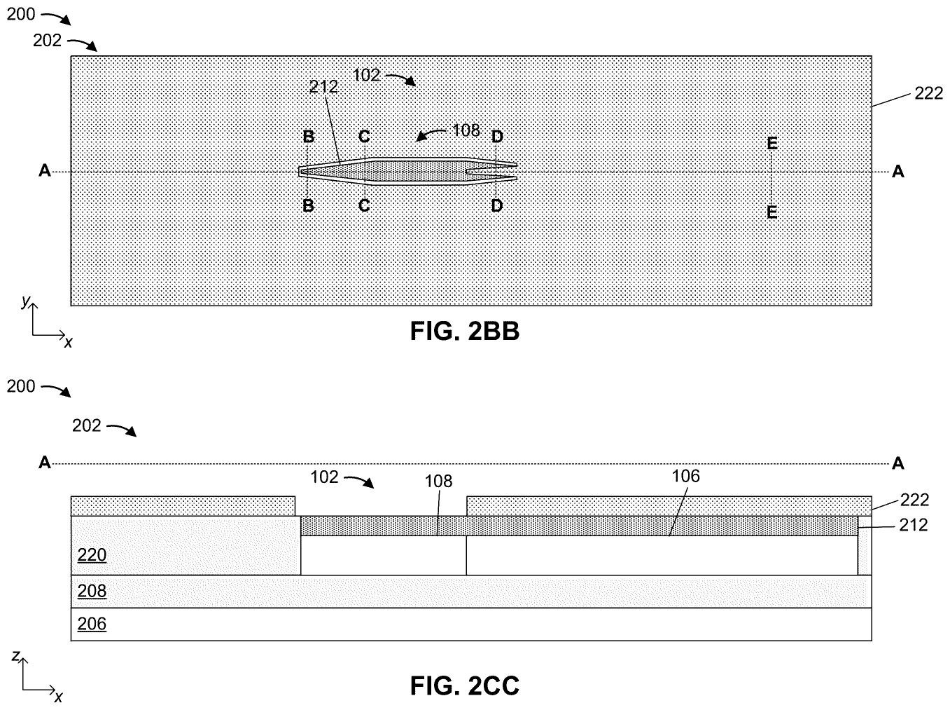

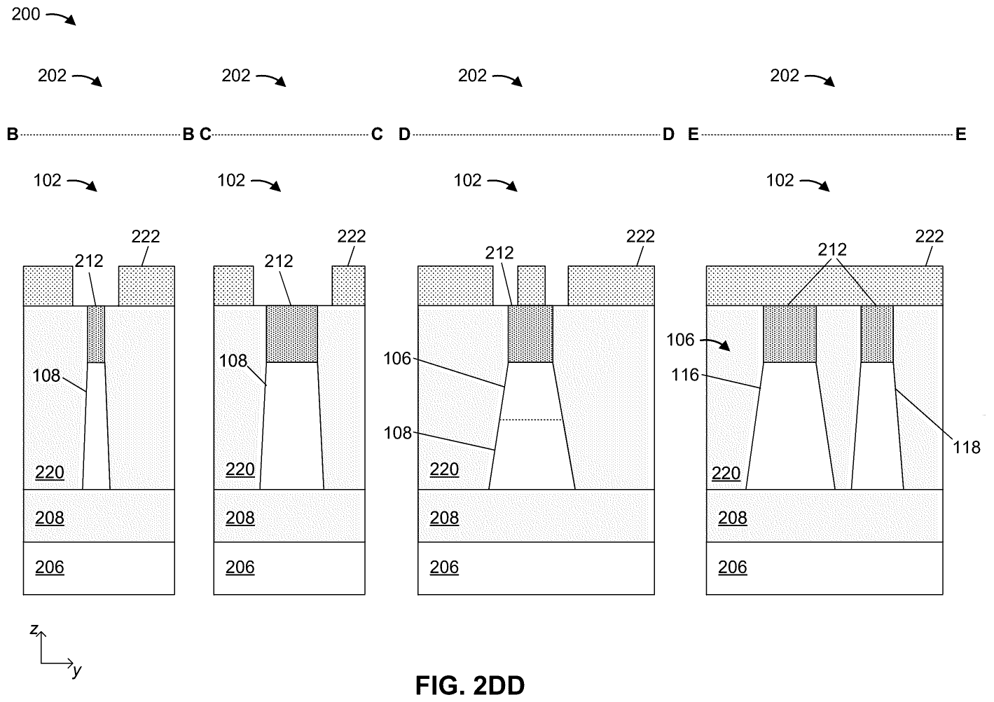

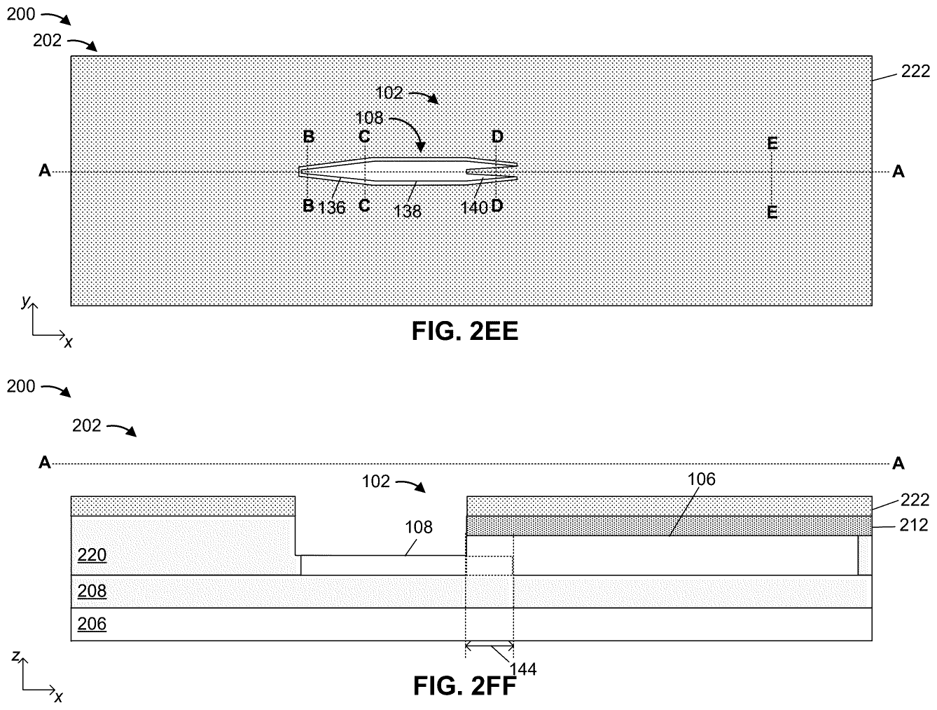

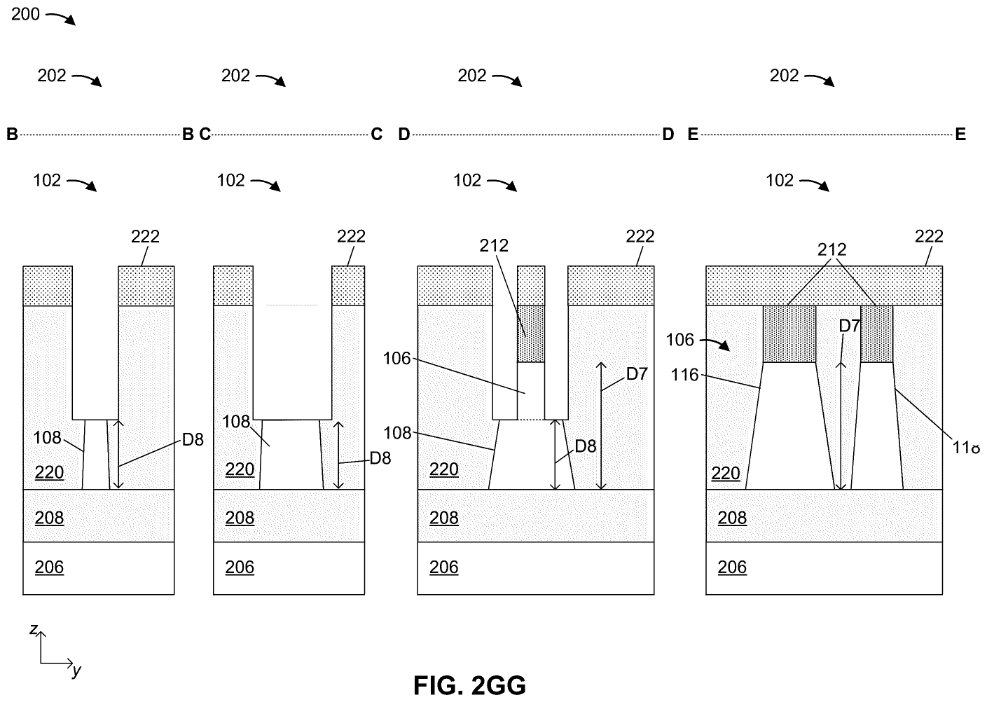

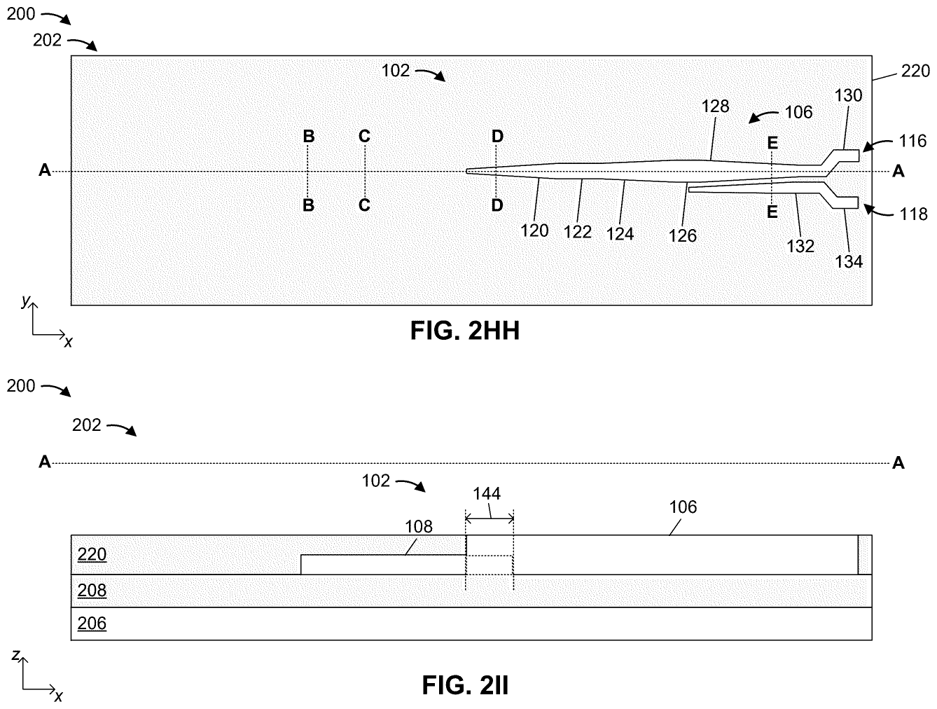

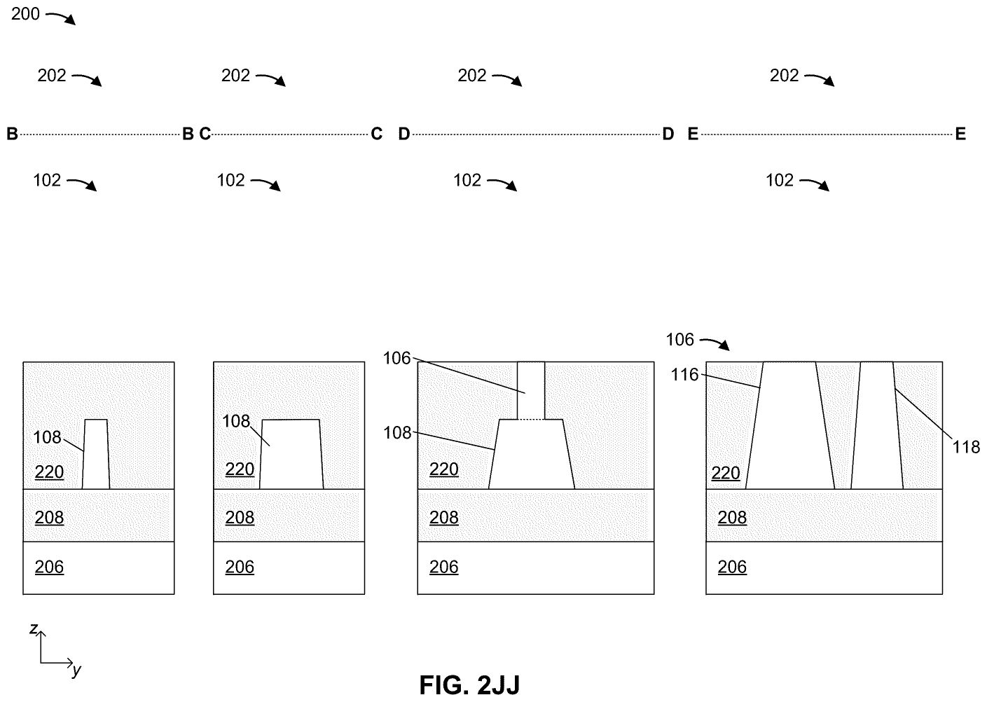

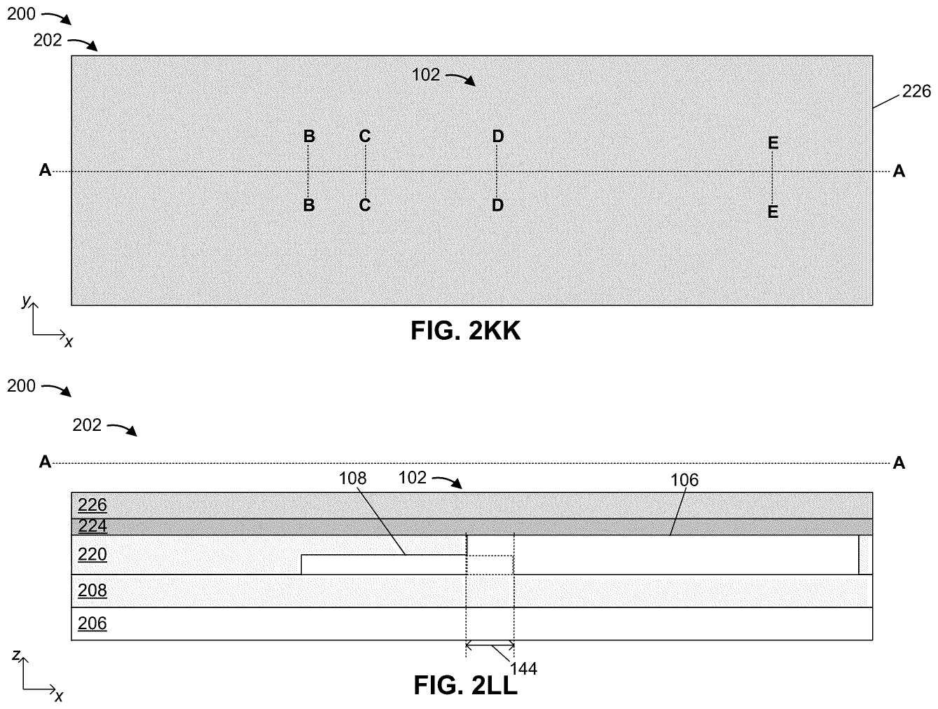

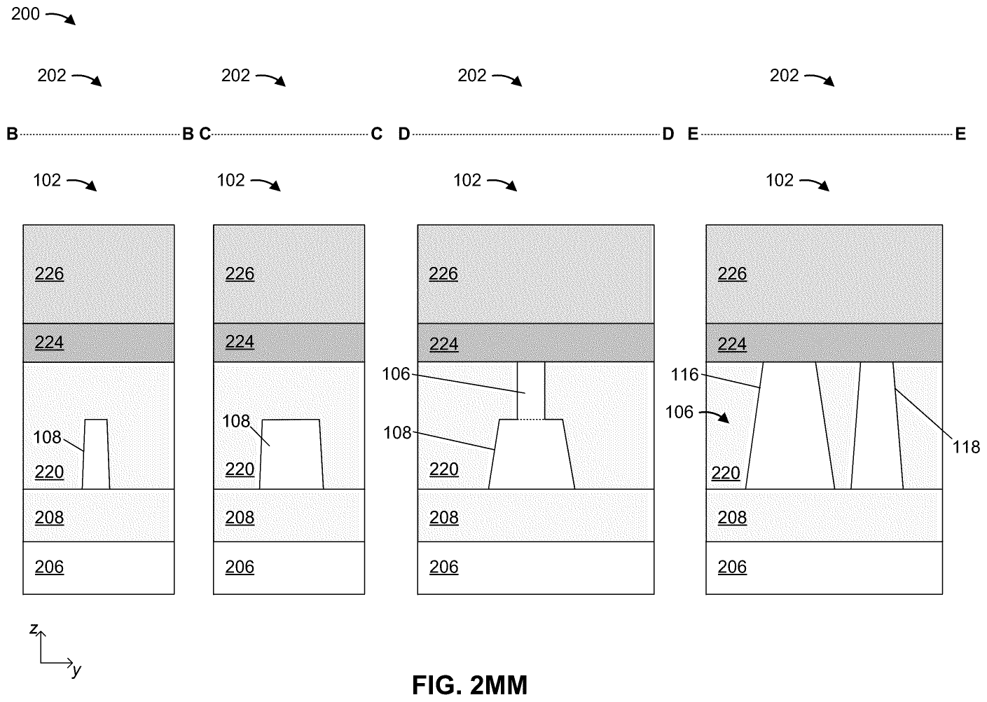

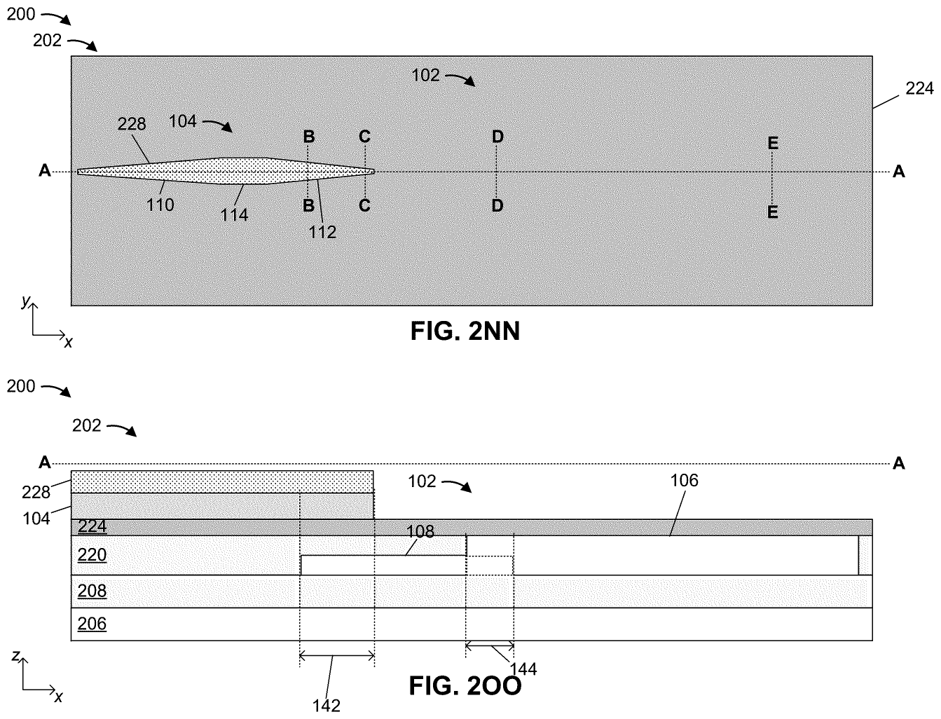

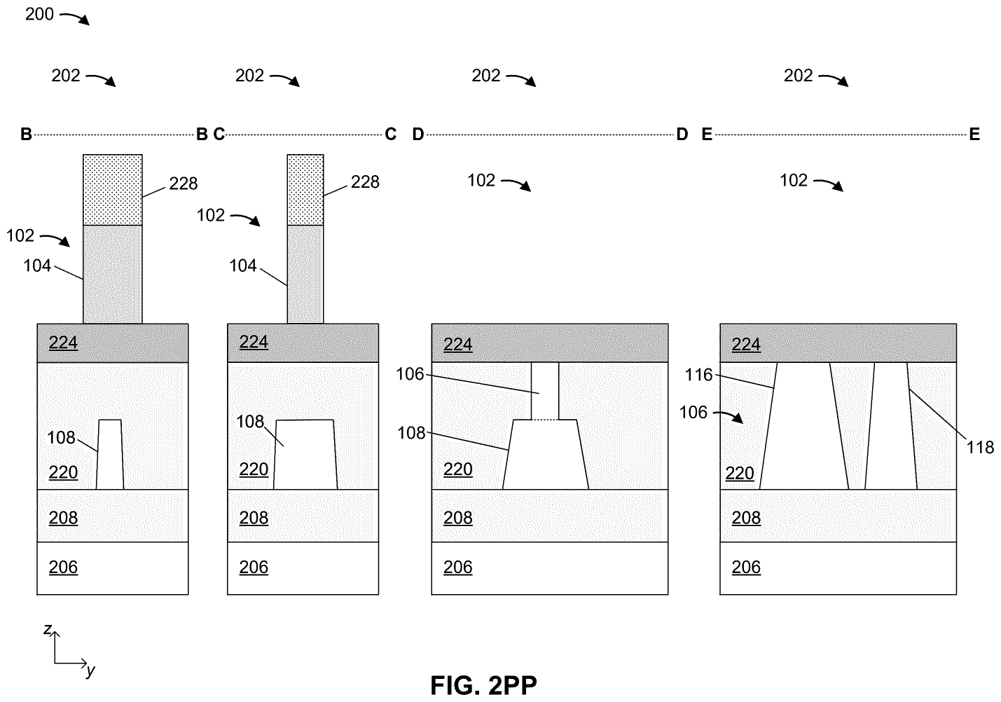

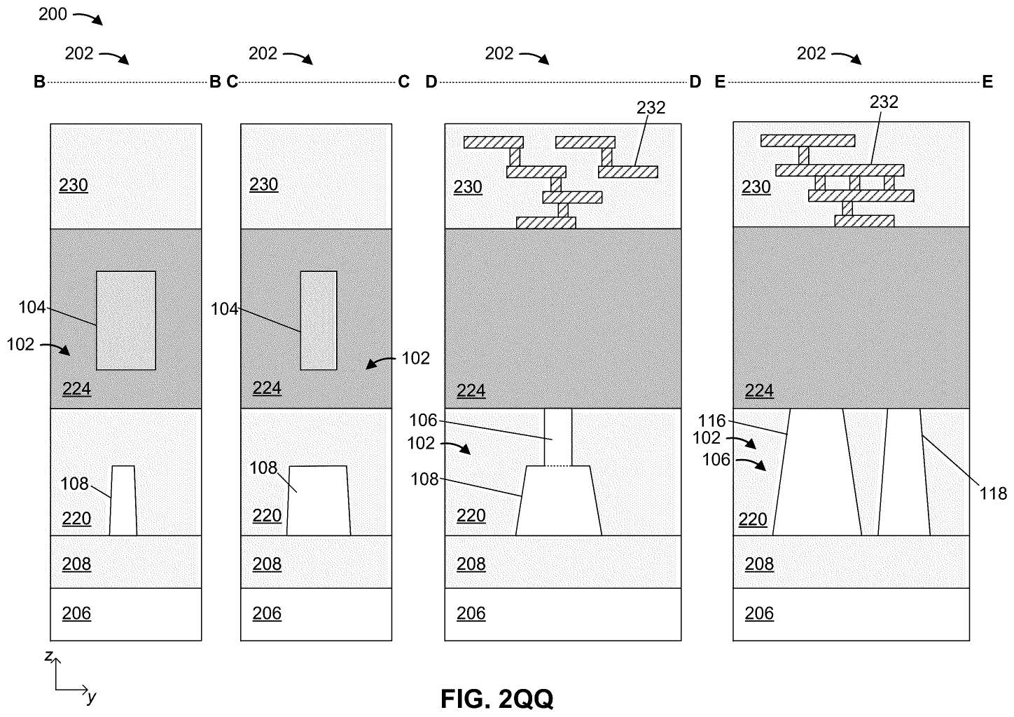

The dimension D3 may also be included in a range of approximately 80 degrees to approximately 85 degrees in that the tapered section 138 of the coupling waveguide 108 may be formed along with the tapered section 120 of the PSR waveguide 106, as described in connection with FIGS. 2A-2QQ. Alternatively, the tapered section 138 may be formed to have another sidewall angle.

As indicated above, FIGS. 1A-1C are provided as an example. Other examples may differ from what is described with regard to FIGS. 1A-1C.

FIGS. 2A-2QQ are diagrams of an example implementation 200 of forming the example 100 of the photonic integrated circuit 102 described in connection with FIGS. 1A-1C. In some implementations, one or more of the semiconductor processing operations described in connection with FIGS. 2A-2QQ may be performed using one or more semiconductor processing tools, such as a deposition tool, an exposure tool, a developer tool, an etch tool, a planarization tool, a plating tool, an ion implantation tool, and/or a wafer/die transport tool, among other examples. One or more of FIGS. 2A-2QQ are illustrated from the top view in FIG. 1A, from the cross-section view along line A-A in FIG. 1B, and/or from the cross-section views along lines B-B, C-C, D-D, and E-E in FIG. 1C.

Turning to FIGS. 2A-2C, a semiconductor device 202 may be provided. The semiconductor device 202 may be provided as a substrate 204, which may include a silicon on insulator (SOI) substrate (or SOI wafer) and/or another type of substrate. The substrate 204 may include a semiconductor substrate 206 (e.g., a silicon (Si) substrate and/or another type of semiconductor substrate), a dielectric layer 208 (e.g., a buried oxide or bottom oxide (BOX) layer and/or another type of insulator layer) over and/or on the semiconductor substrate 206, and a semiconductor layer 210 (e.g., a silicon (Si) layer and/or another type of semiconductor layer) over and/or on the dielectric layer 208.

Alternatively, the semiconductor substrate 206 may be provided as a semiconductor wafer, a deposition tool may be used to form the dielectric layer 208 over and/or on the semiconductor substrate 206, and a deposition tool may form the semiconductor layer 210 over and/or on the dielectric layer 208. A deposition tool may be used to form the dielectric layer 208 using a chemical vapor deposition (CVD) technique, a physical vapor deposition (PVD) technique, an oxidation technique (e.g., a thermal oxidation technique), and/or another type of deposition technique. A deposition tool may be used to form the semiconductor layer 210 using a CVD technique, a PVD technique, an epitaxy technique, and/or another type of deposition technique.

As further shown in FIGS. 2A-2C, a masking layer 212 is formed over and/or on the semiconductor layer 210. The masking layer 212 may include a dielectric material, such as a silicon oxide (SiOₓ), a silicon nitride (SiₓN_{y}), a silicon oxynitride (SiON), and/or another suitable dielectric material. A deposition tool may be used to form the masking layer 212 using a CVD technique, a PVD technique, an atomic layer deposition (ALD) technique, an oxidation technique (e.g., a thermal oxidation technique), and/or another type of deposition technique.

As shown in FIGS. 2D-2F, a patterned masking layer 214 (e.g., a patterned photoresist layer) may be formed on the masking layer 212. In some implementations, a deposition tool may be used to form a photoresist layer on the masking layer 212 using a spin-coating technique and/or another suitable type of deposition technique. An exposure tool may be used to expose the photoresist layer to a radiation source to form a pattern in the photoresist layer. A developer tool may be used to develop and remove portions of the photoresist layer to expose the pattern, thereby resulting in the patterned masking layer 214.

As shown in FIGS. 2G-2I, the pattern in the patterned masking layer 214 may be used to etch the masking layer 212 such that the pattern in the patterned masking layer 214 is transferred to the masking layer 212. An etch tool may be used to etch the masking layer 212 to transfer the pattern from the patterned masking layer 214 to the masking layer 212. In some implementations, the etch operation includes a plasma etch operation, a wet chemical etch operation, and/or another type of etch operation. In some implementations, a photoresist removal tool may be used to remove the remaining portions of the patterned masking layer 214 (e.g., using a chemical stripper, plasma ashing, and/or another technique).

As shown in FIGS. 2J-2L, the semiconductor layer 210 may be etched based on the pattern in the masking layer 212. An etch tool may be used to etch the semiconductor layer 210 to form the PSR waveguide 106 and the coupling waveguide 108 each to a first depth in the semiconductor layer 210 corresponding to a first thickness (indicated in FIG. 2L as dimension D6). In some implementations, the etch operation includes a plasma etch operation, a wet chemical etch operation, and/or another type of etch operation.

As shown in FIGS. 2M-20, another patterned masking layer 216 (e.g., a patterned photoresist layer) is formed over a portion of the semiconductor layer 210 and over a portion of the coupling waveguide 108. For example, the patterned masking layer 216 may be formed over the tapered section 136 of the coupling waveguide 108. The tapered section 138 and the transition section 140 of the coupling waveguide 108, and the PSR waveguide 106, may be exposed through the patterned masking layer 216.

In some implementations, a deposition tool may be used to form a photoresist layer on the PSR waveguide 106, on the coupling waveguide 108, and on the semiconductor layer 210 using a spin-coating technique and/or another suitable type of deposition technique. An exposure tool may be used to expose the photoresist layer to a radiation source to form a pattern in the photoresist layer. A developer tool may be used to develop and remove portions of the photoresist layer from the PSR waveguide 106, from the tapered section 138 and the transition section 140 of the coupling waveguide 108, and from portions of the semiconductor layer 210 to expose the pattern, thereby resulting in the patterned masking layer 216.

As shown in FIGS. 2P-2R, the portions of the semiconductor layer 210 exposed through the patterned masking layer 216 may be etched. An etch tool may be used to perform an etch operation to etch the portions of the semiconductor layer 210 around the PSR waveguide 106 and the portions of the semiconductor layer 210 around the tapered section 138 and the transition section 140 of the coupling waveguide 108. In some implementations, the etch operation includes a plasma etch operation, a wet chemical etch operation, and/or another type of etch operation.

The etch operation may be performed to etch through the semiconductor layer 210 to the dielectric layer 208 to increase the PSR waveguide 106, and the tapered section 138 and the transition section 140 of the coupling waveguide 108, to a second thickness (indicated in FIG. 2R as dimension D7). The masking layer 212 on the PSR waveguide 106 and the tapered section 138 and the transition section 140 of the coupling waveguide 108 protect the top surfaces of the PSR waveguide 106, and top surfaces of the tapered section 138 and the transition section 140 of the coupling waveguide 108, from being etched in the etch operation. The patterned masking layer 216 protects the tapered section 136 of the coupling waveguide 108 from being etched in the etch operation. Thus, the tapered section 136 of the coupling waveguide 108 remains at the first depth in the semiconductor layer 210, corresponding to a first thickness (dimension D6) after the etch operation.

As further shown in FIG. 2R, the etch operation results in the tapered section 138 of the coupling waveguide 108 at the location of the D-D cross-section, the through segment 116 of the PSR waveguide 106 at the location of the E-E cross-section, and the cross segment 118 of the PSR waveguide 106 at the location of the E-E cross-section each having a sidewall angle corresponding to the dimension D3, the dimension D4, and the dimension D5, respectively. In some implementations, the dimension D3, the dimension D4, and the dimension D5 are each included in a range of approximately 80 degrees to approximately 85 degrees. However, other values for the range are within the scope of the present disclosure.

As shown in FIGS. 2S-2U, the remaining portions of the patterned masking layer 216 may be removed after the etch operation described in connection with FIGS. 2P-2R. A photoresist removal tool may be used to remove the remaining portions of the patterned masking layer 216 using a chemical stripper, plasma ashing, and/or another technique.

As further shown in FIGS. 2S-2U, another patterned masking layer 218 (e.g., a patterned photoresist layer) may be formed over the PSR waveguide 106, over the tapered section 138 and the transition section 140 of the coupling waveguide 108, after the remaining portions of the patterned masking layer 216 are removed. The tapered section 136 of the coupling waveguide 108 may be exposed through the patterned masking layer 218.

In some implementations, a deposition tool may be used to form a photoresist layer on the PSR waveguide 106, on the coupling waveguide 108, and on the remaining portions of the semiconductor layer 210 using a spin-coating technique and/or another suitable type of deposition technique. An exposure tool may be used to expose the photoresist layer to a radiation source to form a pattern in the photoresist layer. A developer tool may be used to develop and remove portions of the photoresist layer from the tapered section 136 of the coupling waveguide 108 and from the remaining portions of the semiconductor layer 210 to expose the pattern, thereby resulting in the patterned masking layer 218.

As shown in FIGS. 2V-2X, the portions of the remaining semiconductor layer 210 exposed through the patterned masking layer 218 may be etched. An etch tool may be used to perform an etch operation to etch the remaining portions of the semiconductor layer 210 around the tapered section 136 of the coupling waveguide 108. In some implementations, the etch operation includes a plasma etch operation, a wet chemical etch operation, and/or another type of etch operation.

The etch operation may be performed to etch through the semiconductor layer 210 to the dielectric layer 208 to increase the tapered section 136 of the coupling waveguide 108 to the second thickness (indicated in FIG. 2X as dimension D7). The masking layer 212 on the tapered section 136 of the coupling waveguide 108 protects the top surface of the tapered section 136 of the coupling waveguide 108 from being etched in the etch operation. The patterned masking layer 218 protects the PSR waveguide 106, and protects the tapered section 138 and the transition section 140 of the coupling waveguide 108, from being etched in the etch operation.

In this way, a first set of masking and etching operations (described in connection with FIGS. 2M-2R) is performed to form the tapered section 138 of the coupling waveguide 108 at the location of the D-D cross-section, the through segment 116 of the PSR waveguide 106 at the location of the E-E cross-section, and the cross segment 118 of the PSR waveguide 106 at the location of the E-E cross-section to each have a sidewall angle corresponding to the dimension D3, the dimension D4, and the dimension D5, respectively. A second set of masking and etching operations (described in connection with FIGS. 2S-2X) is performed to form the tapered section 136 of the coupling waveguide 108 at the location of the B-B cross-section and at the location of the C-C cross-section to have a sidewall angle corresponding to the dimension D1 and a sidewall angle corresponding the dimension D2, respectively. In this way, the tapered section 136 may be etched in a manner that results in the sidewall angle of the tapered section 136 being greater than the sidewall angle of the PSR waveguide 106. In some implementations, the dimension D1 and the dimension D2 are each included in a range of approximately 86 degrees to approximately 88 degrees. However, other values for the range are within the scope of the present disclosure.

Different etch parameters may be used for the first set of masking and etching operations (described in connection with FIGS. 2M-2R) and the second set of masking and etching operations (described in connection with FIGS. 2S-2X) to achieve the different sidewalls angles. For example, different sets of plasma-based etching parameters may be used for the first set of masking and etching operations (described in connection with FIGS. 2M-2R) and for the second set of masking and etching operations (described in connection with FIGS. 2S-2X) to achieve the different sidewalls angles.

In some implementations, a lower plasma bias voltage may be used in the first set of masking and etching operations (described in connection with FIGS. 2M-2R) to achieve a lesser sidewall angle for the tapered section 138 of the coupling waveguide 108 at the location of the D-D cross-section, the through segment 116 of the PSR waveguide 106 at the location of the E-E cross-section, and the cross segment 118 of the PSR waveguide 106 at the location of the E-E cross-section. A higher plasma bias voltage may be used in the second set of masking and etching operations (described in connection with FIGS. 2S-2X) than in the first set of masking and etching operations (described in connection with FIGS. 2M-2R) to perform a more vertical etch in the second set of masking and etching operations (described in connection with FIGS. 2S-2X) to achieve a greater sidewall angle for the tapered section 136 of the coupling waveguide 108 at the location of the B-B cross-section and at the location of the C-C cross-section. The higher plasma bias voltage may result in a more vertical directional ion bombardment in the second set of masking and etching operations (described in connection with FIGS. 2S-2X), resulting in the greater sidewall angle for the tapered section 136 of the coupling waveguide 108 at the location of the B-B cross-section and at the location of the C-C cross-section. In some implementations, a lower chamber pressure may be used in the first set of masking and etching operations (described in connection with FIGS. 2M-2R) to achieve a lesser sidewall angle for the tapered section 138 of the coupling waveguide 108 at the location of the D-D cross-section, the through segment 116 of the PSR waveguide 106 at the location of the E-E cross-section, and the cross segment 118 of the PSR waveguide 106 at the location of the E-E cross-section. A higher chamber pressure may be used in the second set of masking and etching operations (described in connection with FIGS. 2S-2X) than in the first set of masking and etching operations (described in connection with FIGS. 2M-2R) to perform a more vertical etch in the second set of masking and etching operations (described in connection with FIGS. 2S-2X) to achieve a greater sidewall angle for the tapered section 136 of the coupling waveguide 108 at the location of the B-B cross-section and at the location of the C-C cross-section. The higher chamber pressure may facilitate greater control over the flow and directionality of ion bombardment in the second set of masking and etching operations (described in connection with FIGS. 2S-2X), resulting in the greater sidewall angle for the tapered section 136 of the coupling waveguide 108 at the location of the B-B cross-section and at the location of the C-C cross-section.

As shown in FIGS. 2Y-2AA, the remaining portions of the patterned masking layer 216 may be removed after the etch operation described in connection with FIGS. 2V-2X. A photoresist removal tool may be used to remove the remaining portions of the patterned masking layer 216 using a chemical stripper, plasma ashing, and/or another technique.

As further shown in FIGS. 2Y-2AA, a dielectric layer 220 may be formed around the PSR waveguide 106 and around the coupling waveguide 108. The dielectric layer 220 may be referred to as a shallow trench isolation (STI) layer. In some implementations, an STI liner is first deposited on sidewalls of the PSR waveguide 106 and on sidewalls of the coupling waveguide 108 prior to formation of the dielectric layer 220. The dielectric layer 220 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

A deposition tool may be used to deposit the dielectric layer 220 using a CVD technique, a PVD technique, an oxidation technique (e.g., a thermal oxidation technique), and/or another type of deposition technique. In some implementations, a planarization tool is used to planarize the dielectric layer 220 after the dielectric layer 220 is deposited. In some implementations, the dielectric layer 220 may be planarized such that the top surface of the dielectric layer 220 is approximately co-planar with the top surface of the masking layer 212.

As shown in FIGS. 2BB-2DD, a patterned masking layer 222 (e.g., a patterned photoresist layer) may be formed over the dielectric layer 220 and over and/or on the PSR waveguide 106. The patterned masking layer 222 is formed such that the coupling waveguide 108 is exposed through the patterned masking layer 222. In some implementations, portions of the dielectric layer 220 around the coupling waveguide 108 are also exposed through the patterned masking layer 222.

In some implementations, a deposition tool may be used to form a photoresist layer on the PSR waveguide 106, on the coupling waveguide 108, and on the dielectric layer 220 using a spin-coating technique and/or another suitable type of deposition technique. An exposure tool may be used to expose the photoresist layer to a radiation source to form a pattern in the photoresist layer. A developer tool may be used to develop and remove portions of the photoresist layer from the coupling waveguide 108 to expose the pattern, thereby resulting in the patterned masking layer 222.

As shown in FIGS. 2EE-2GG, the coupling waveguide 108 may be etched based on patterned masking layer 218. An etch tool may be used to perform an etch operation to etch the coupling waveguide 108 to reduce a z-direction thickness of the coupling waveguide 108. In some implementations, the etch operation includes a plasma etch operation, a wet chemical etch operation, and/or another type of etch operation.

As shown in FIG. 2FF, the etch operation results in formation of the coupling region 144 between the coupling waveguide 108 and the PSR waveguide 106. As shown in FIG. 2GG, the etch operation results in the thickness of the coupling waveguide 108 being decreased from the second thickness (dimension D7) to a third thickness (indicated in FIG. 2GG as dimension D8). The patterned masking layer 218 protects the PSR waveguide 106 from being etched in the etching operation. Accordingly, the PSR waveguide 106 remains at the second thickness (dimension D7) after the etch operation.

As shown in FIGS. 2HH-2JJ, the dielectric layer 220 (e.g., the STI layer) is rebuilt after the etch operation described in connection with FIGS. 2EE-2GG. A deposition tool may be used to deposit the additional material of the dielectric layer 220 using a CVD technique, a PVD technique, an oxidation technique (e.g., a thermal oxidation technique), and/or another type of deposition technique.

As further shown in FIGS. 2HH-2JJ, a planarization tool is used to perform a planarization operation to planarize the dielectric layer 220 after the additional material of the dielectric layer 220 is deposited. The remaining portions of the masking layer 212 may also be removed in the planarization operation. In some implementations, the dielectric layer 220 may be planarized such that the top surface of the dielectric layer 220 is approximately co-planar with the top surface of the PSR waveguide 106. The coupling waveguide 108 may be encapsulated in the dielectric layer 220 due to the z-direction thickness of the PSR waveguide 106 being greater than the z-direction thickness of the coupling waveguide 108.

As shown in FIGS. 2KK-2MM, another dielectric layer 224 (e.g., an interlayer dielectric (ILD) layer) is formed over and/or on the dielectric layer 220, over and/or on the PSR waveguide 106, and/or above the coupling waveguide 108. A deposition tool may be used to deposit the dielectric layer 224 using a CVD technique, a PVD technique, an oxidation technique (e.g., a thermal oxidation technique), and/or another type of deposition technique. In some implementations, a planarization tool is used to perform a planarization operation to planarize the dielectric layer 224 after the dielectric layer 224 is deposited. The dielectric layer 224 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silicate glass (FSG), carbon doped silicon oxide, and/or another dielectric material.

As further shown in FIGS. 2KK-2MM, another dielectric layer 226 is formed over and/or on the dielectric layer 224. A deposition tool may be used to deposit the dielectric layer 226 using a CVD technique, a PVD technique, an oxidation technique (e.g., a thermal oxidation technique), and/or another type of deposition technique. In some implementations, a planarization tool is used to perform a planarization operation to planarize the dielectric layer 226 after the dielectric layer 226 is deposited. The edge coupler waveguide 104 may be formed from the dielectric layer 226. Accordingly, the dielectric layer 226 may include one or more dielectric materials, such as a silicon nitride material (SiₓN_{y} such as Si₃N₄), an aluminum oxide material (AlₓO_{y} such as Al₂O₃), an aluminum nitride material (AlN), a hafnium oxide material (HfOₓ such as HfO₂), a titanium oxide material (TiOₓ such as TiO₂), a zinc oxide material (ZnO), and/or a germanium oxide material (GeOₓ such as GeO₂), among other examples.

As shown in FIGS. 2NN-2PP, a patterned masking layer 228 (e.g., a patterned photoresist layer) may be used to etch the dielectric layer 226 to form the edge coupler waveguide 104 from the dielectric layer 226. In some implementations, a deposition tool may be used to form a photoresist layer on the dielectric layer 226 using a spin-coating technique and/or another suitable type of deposition technique. An exposure tool may be used to expose the photoresist layer to a radiation source to form a pattern in the photoresist layer. A developer tool may be used to develop and remove portions of the photoresist layer to expose the pattern, thereby resulting in the patterned masking layer 228. The dielectric layer 226 may then be etched based on the pattern in the masking layer 218 to form the edge coupler waveguide 104. In some implementations, the etch operation includes a plasma etch operation, a wet chemical etch operation, and/or another type of etch operation. The dielectric layer 226 is etched such that the tapered section 112 of the edge coupler waveguide 104 is formed over a portion of the coupling waveguide 108 (e.g., the tapered section 136 of the coupling waveguide 108), which results in formation of the coupling region 142 between the edge coupler waveguide 104 and the coupling waveguide 108.

As shown in FIG. 2QQ, additional material of the dielectric layer 224 is deposited. A deposition tool may be used to deposit the additional material of the dielectric layer 224 using a CVD technique, a PVD technique, an oxidation technique (e.g., a thermal oxidation technique), and/or another type of deposition technique. A planarization tool is used to perform a planarization operation to planarize the dielectric layer 224 after the additional material of the dielectric layer 224 is deposited. The edge coupler waveguide 104 may be encapsulated in the dielectric layer 224 after the additional material of the dielectric layer 224 is deposited.

As further shown in FIG. 2QQ, an interconnect layer of the semiconductor device 202 is formed above the dielectric layer 224. The interconnect layer may be referred to as a back end region or a back end of line (BEOL) region of the semiconductor device 202. The interconnect layer includes a dielectric region 230 that may include a plurality of dielectric layers that are arranged in the z-direction. The dielectric layers may include ILD layers, intermetal dielectric (IMD) layers, etch stop layers (ESLs), and/or another type of dielectric layers. The dielectric layers in the dielectric region 230 may each include an oxide (e.g., a silicon oxide (SiOₓ) and/or another oxide material), an undoped silicate glass (USG), a boron-containing silicate glass (BSG), a fluorine-containing silicate glass (FSG), and/or another suitable dielectric material. In some implementations, a dielectric layer in the dielectric region 230 includes an extreme low dielectric constant (ELK) dielectric material having a dielectric constant that is less than approximately 2.5. In some implementations, a dielectric layer in the dielectric region 230 may include a silicon nitride (SiₓN_{y}), silicon carbide (SiC), silicon oxynitride (SiON), and/or another suitable dielectric material.

The interconnect layer may further include a plurality of conductive interconnects 232 in the dielectric layers of the dielectric region 230. The conductive interconnects may include a combination of conductive structures (e.g., trenches, conductive lines) that are interconnected by interconnect structures (e.g., vias). The conductive interconnects 232 may each include one or more electrically conductive materials such as tungsten (W), cobalt (Co), ruthenium (Ru), titanium (Ti), aluminum (Al), copper (Cu), gold (Au), and/or a combination thereof, among other examples of electrically conductive materials.

The conductive interconnects 232 of the interconnect layer may be arranged in the dielectric region 230 in a vertical manner (e.g., in the z-direction) to facilitate electrical signals and/or power to be routed through the dielectric region 230. The conductive interconnects 232 may be arranged in alternating layers of metallization layers (referred to as “M”-layers) and via layers (referred to as “V”-layers). Each metallization layer may include one or more conductive interconnects 232 that are laterally arranged in an x-y plane in the dielectric region 230, and each via layer may include one or more conductive interconnects 232 that are laterally arranged in an x-y plane in the dielectric region 230. As an example, a metal-0 (M0) layer (including one or more conductive interconnects 232) may be formed at the bottom of the dielectric region 230, a via-1 (V1) layer (including one or more conductive interconnects 232) may be formed above and coupled with the M1 layer in the dielectric region 230, a metal-1 (M1) layer may be formed above and coupled with the V1 layer in the dielectric region 230, a via-2 (V2) layer may be formed above and coupled with the M1 layer in the dielectric region 230, a metal-2 (M2) layer may be formed above and electrically coupled with the V2 layer in the dielectric region 230, and so on.

As indicated above, FIGS. 2A-2QQ are provided as an example. Other examples may differ from what is described with regard to FIGS. 2A-2QQ.

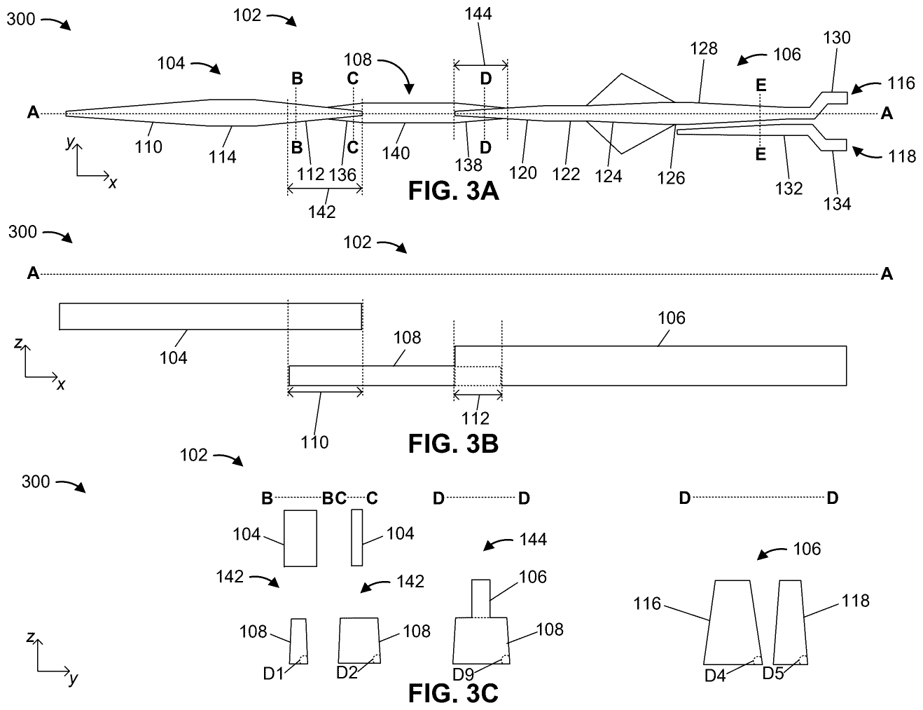

FIGS. 3A-3C are diagrams of an example 300 of a photonic integrated circuit 102 described herein. The photonic integrated circuit 102 may include an optical coupling circuit that includes an edge coupler waveguide 104, a PSR waveguide 106, and a coupling waveguide 108 that optically couples the edge coupler waveguide 104 and the PSR waveguide 106. In some implementations, the photonic integrated circuit 102 may be included in a semiconductor device, such as a semiconductor device 202 described herein.

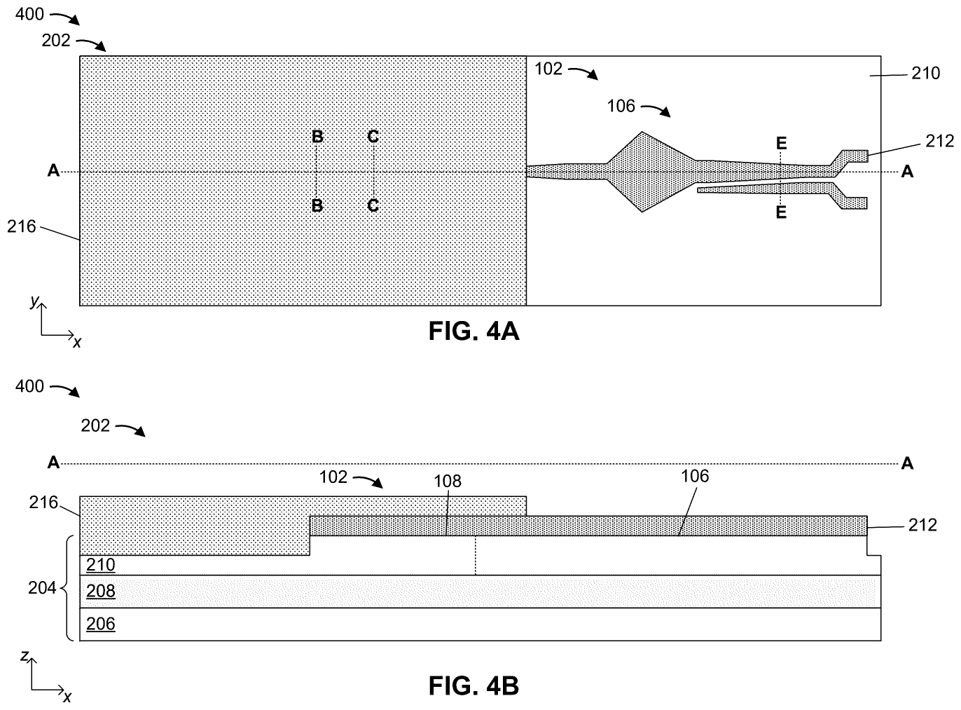

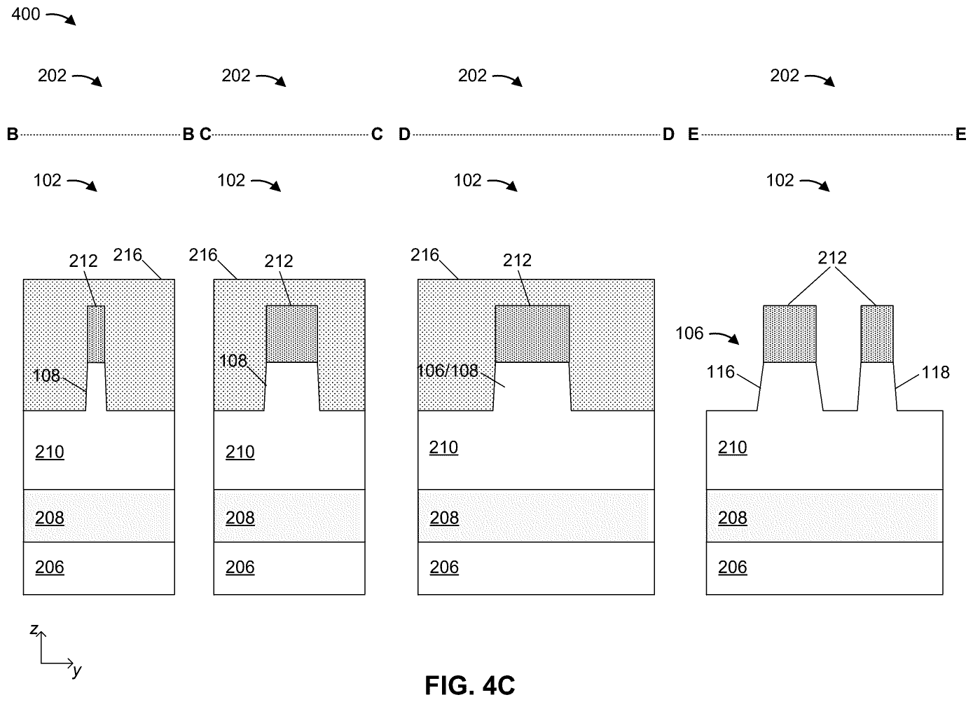

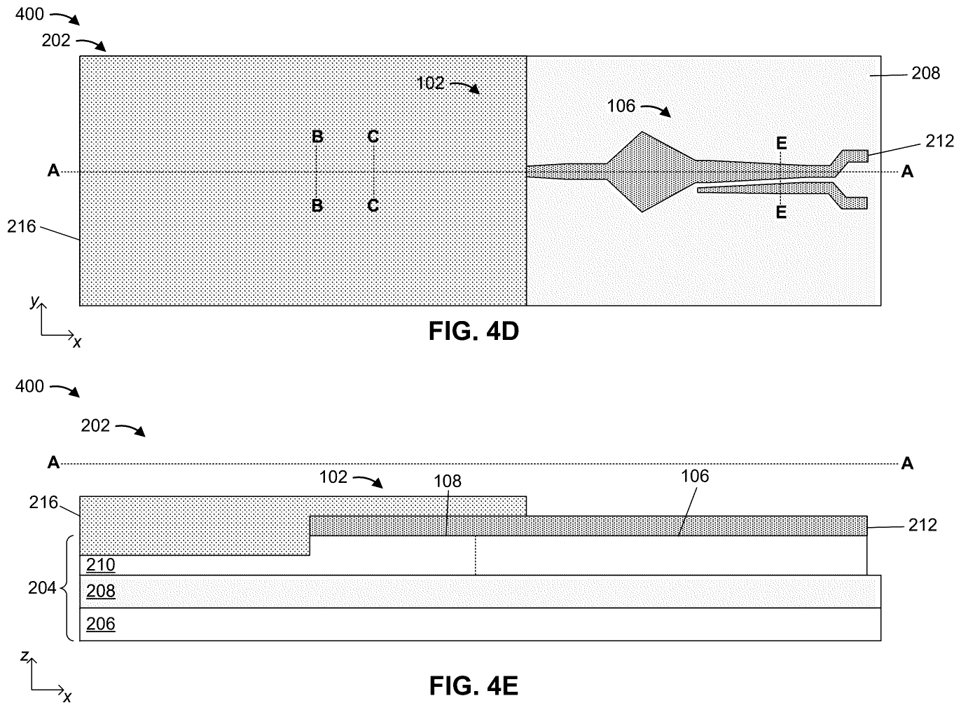

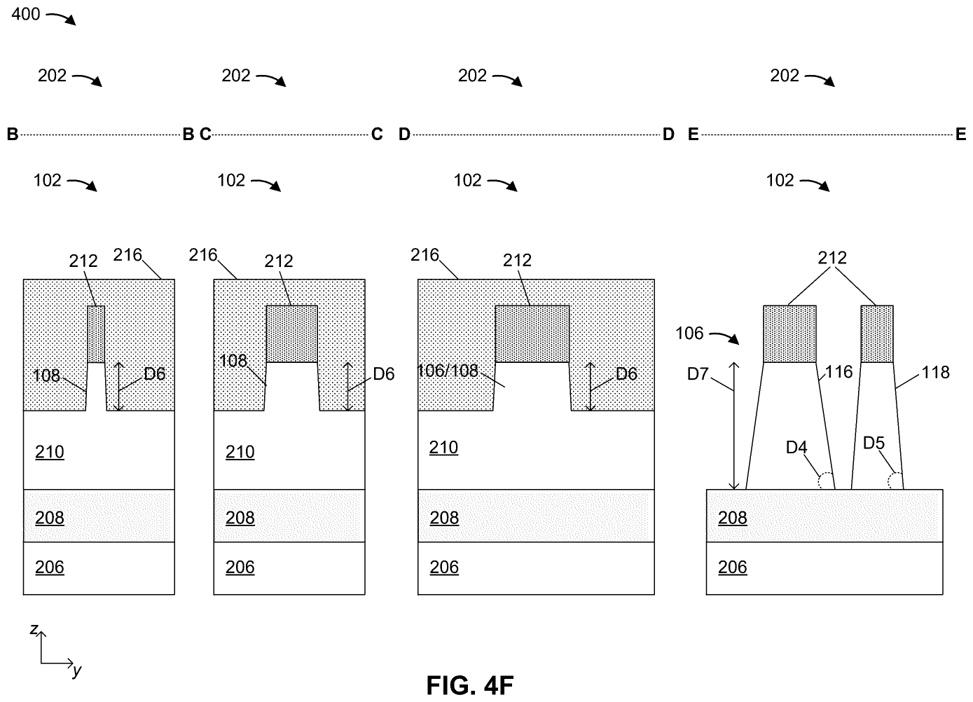

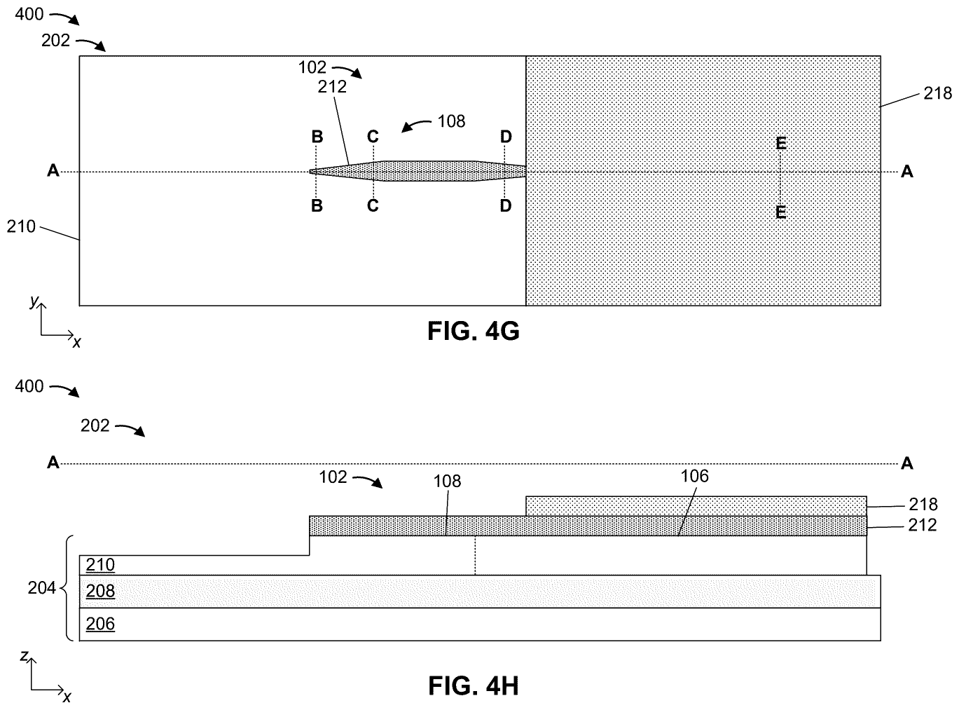

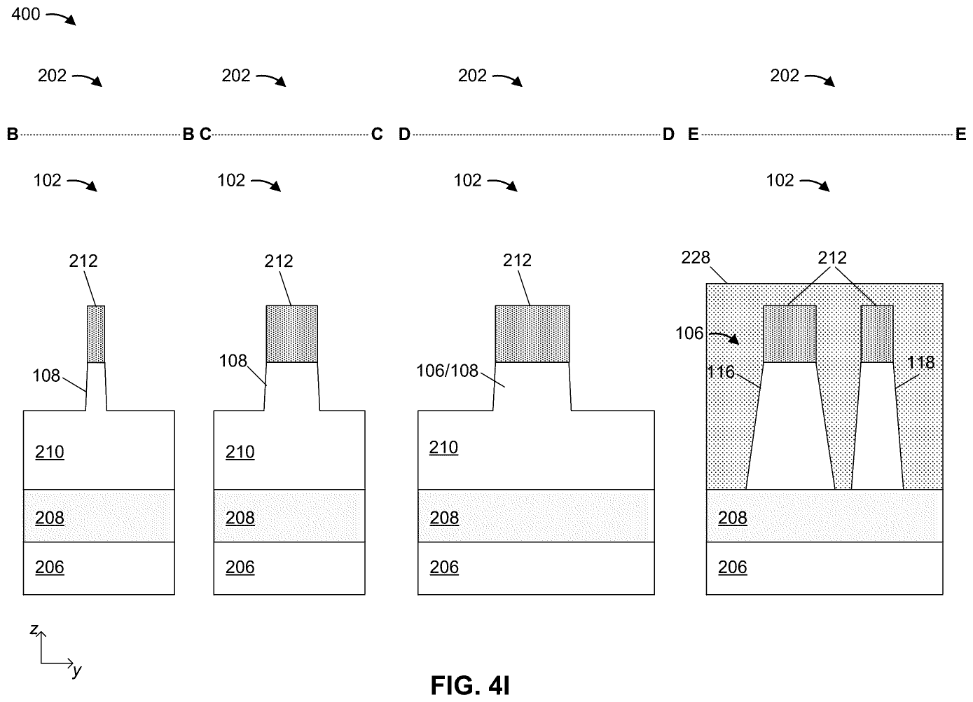

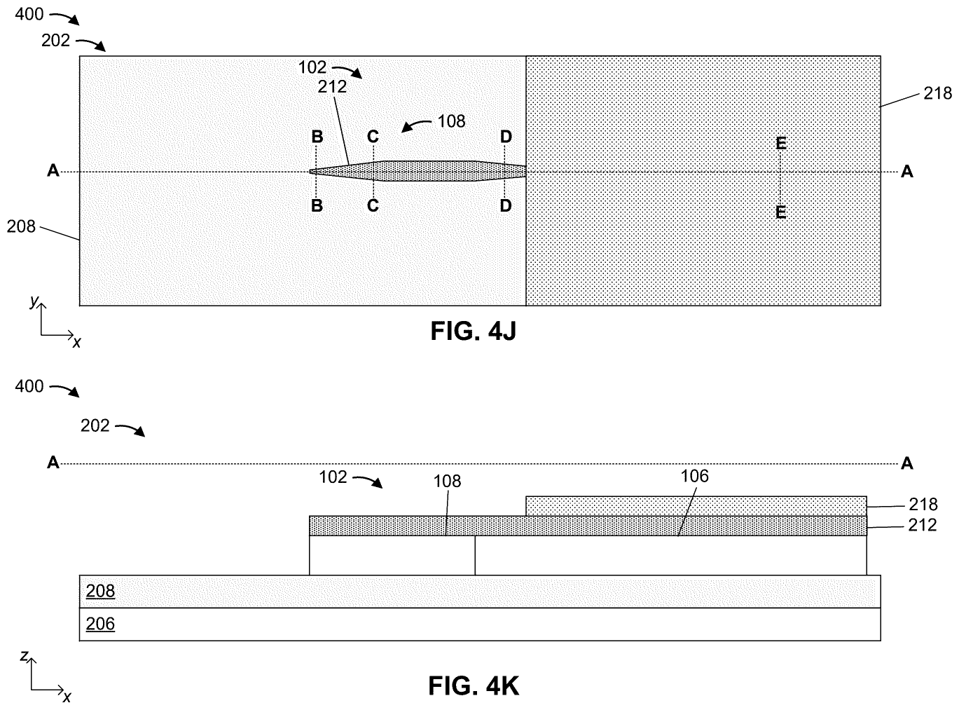

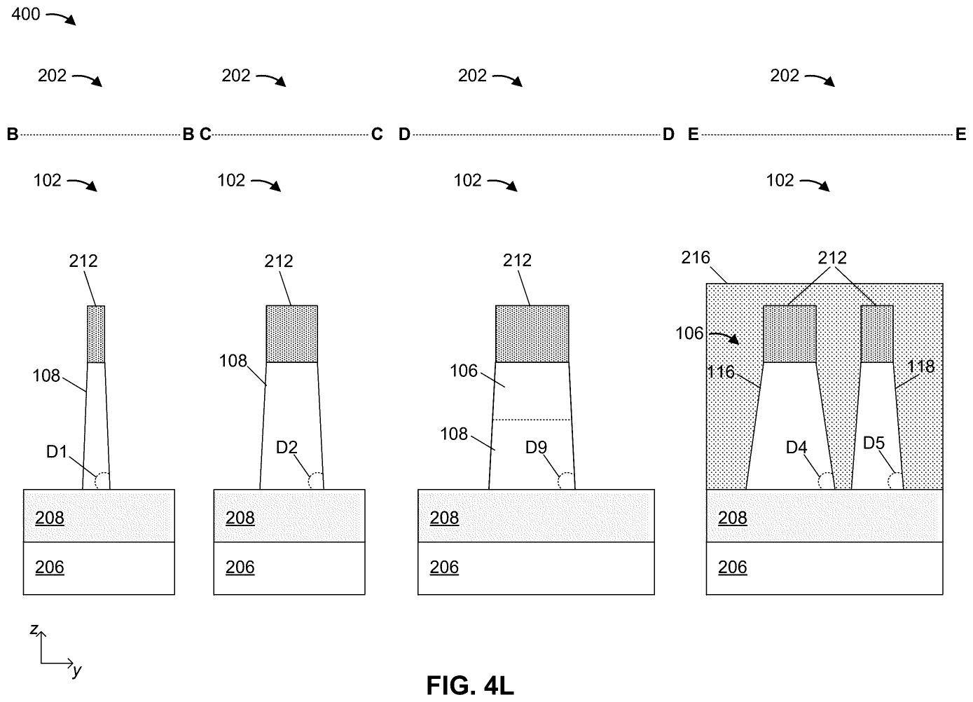

As shown in FIGS. 3A-3C, the example 300 of the photonic integrated circuit 102 includes a similar combination and arrangement of components as the example 100 of the photonic integrated circuit 102 of FIGS. 1A-1C. However, in the example 300 of the photonic integrated circuit 102 in FIGS. 3A-3C, the tapered section 138 of the coupling waveguide 108 has a sidewall angle (indicated in FIG. 3C as dimension D9) at the location of the D-D cross-section in the coupling region 144 that is approximately equal to the dimension D1 and the dimension D2. For example, the dimension D9 may also be included in a range of approximately 86 degrees to approximately 88 degrees in that the tapered section 138 of the coupling waveguide 108 may be formed along with the tapered section 136 of the coupling waveguide 108, as described in connection with FIGS. 4A-4L.

As indicated above, FIGS. 3A-3C are provided as an example. Other examples may differ from what is described with regard to FIGS. 3A-3C.

FIGS. 4A-4L are diagrams of an example implementation 400 of forming the example 100 of the photonic integrated circuit 102 described in connection with FIGS. 3A-3C. In some implementations, one or more of the semiconductor processing operations described in connection with FIGS. 4A-4L may be performed using one or more of the semiconductor processing tools, such as a deposition tool, an exposure tool, a developer tool, an etch tool, a planarization tool, a plating tool, an ion implantation tool, and/or a wafer/die transport tool, among other examples. One or more of FIGS. 4A-4L are illustrated from the top view in FIG. 3A, from the cross-section view along line A-A in FIG. 3B, and/or from the cross-section views along lines B-B, C-C, D-D, and E-E in FIG. 3C.

As shown in FIGS. 4A-4C, operations described in connection with FIGS. 2A-2L may be performed to form the PSR waveguide 106 and the coupling waveguide 108 each to a first depth in the semiconductor layer 210 corresponding to a first thickness (dimension D6).

As further shown in FIGS. 4A-4C, the patterned masking layer 216 is formed in a similar manner as described in connection with FIGS. 2M-20, except that the patterned masking layer 216 is also formed over the tapered section 138 and the transition section 140 of the coupling waveguide 108 in the example implementation 400. The portion of the PSR waveguide 106 above the tapered section 138 of the coupling waveguide 108 is therefore covered by the patterned masking layer 216, as shown in FIG. 4C. The other portions of the PSR waveguide 106 are exposed through the patterned masking layer 216.

As shown in FIGS. 4D-4F, the portions of the semiconductor layer 210 exposed through the patterned masking layer 216 may be etched. An etch tool may be used to perform an etch operation to etch the portions of the semiconductor layer 210 around the exposed portions of the PSR waveguide 106. In some implementations, the etch operation includes a plasma etch operation, a wet chemical etch operation, and/or another type of etch operation.

The etch operation may be performed to etch through the semiconductor layer 210 to the dielectric layer 208 to increase the exposed portions of the PSR waveguide 106 to the second thickness (dimension D7). The patterned masking layer 216 protects the coupling waveguide 108 and the portion of the PSR waveguide 106 on the tapered section 138 of the coupling waveguide 108 from being etched in the etch operation. Thus, the coupling waveguide 108 and the portion of the PSR waveguide 106 on the tapered section 138 of the coupling waveguide 108 remain at the first depth in the semiconductor layer 210 corresponding to the first thickness (dimension D6) after the etch operation. Moreover, the etch operation results in the exposed portions of the PSR waveguide 106, including the through segment 116 of the PSR waveguide 106 at the location of the E-E cross-section and the cross segment 118 of the PSR waveguide 106 at the location of the E-E cross-section, having a sidewall angle corresponding to the dimension D4 and the dimension D5, respectively. In some implementations, the dimension D4 and the dimension D5 are each included in a range of approximately 80 degrees to approximately 85 degrees. However, other values for the range are within the scope of the present disclosure.

As shown in FIGS. 4G-4I, the remaining portions of the patterned masking layer 216 may be removed after the etch operation described in connection with FIGS. 4D-4F. As further shown in FIGS. 4G-4I, the patterned masking layer 218 may be formed over the portions of the PSR waveguide 106 that were etched in the etch operation described in connection with FIGS. 4D-4F.

As shown in FIGS. 4J-4L, the portions of the remaining semiconductor layer 210 exposed through the patterned masking layer 218 may be etched. An etch tool may be used to perform an etch operation to etch the remaining portions of the semiconductor layer 210 around the coupling waveguide 108. In some implementations, the etch operation includes a plasma etch operation, a wet chemical etch operation, and/or another type of etch operation. The etch operation may be performed to etch through the semiconductor layer 210 to the dielectric layer 208 to increase the coupling waveguide 108 to the second thickness (dimension D7). The patterned masking layer 218 protects the PSR waveguide 106 from being etched in the etch operation.

In this way, a first set of masking and etching operations (described in connection with FIGS. 4A-4F) is performed to form PSR waveguide 106, and a second set of masking and etching operations (described in connection with FIGS. 4G-4L) is performed to form the tapered section 136, the tapered section 138, and the transition section 140 of the coupling waveguide 10. In this way, the coupling waveguide 108 may be etched in a manner that results in the sidewall angle of the coupling waveguide 108 being greater than the sidewall angle of the PSR waveguide 106. In some implementations, the dimension D1, the dimension D2, and the dimension D9 of the coupling waveguide 108 are each included in a range of approximately 86 degrees to approximately 88 degrees. However, other values for the range are within the scope of the present disclosure.

As indicated above, FIGS. 4A-4L are provided as an example. Other examples may differ from what is described with regard to FIGS. 4A-4L.

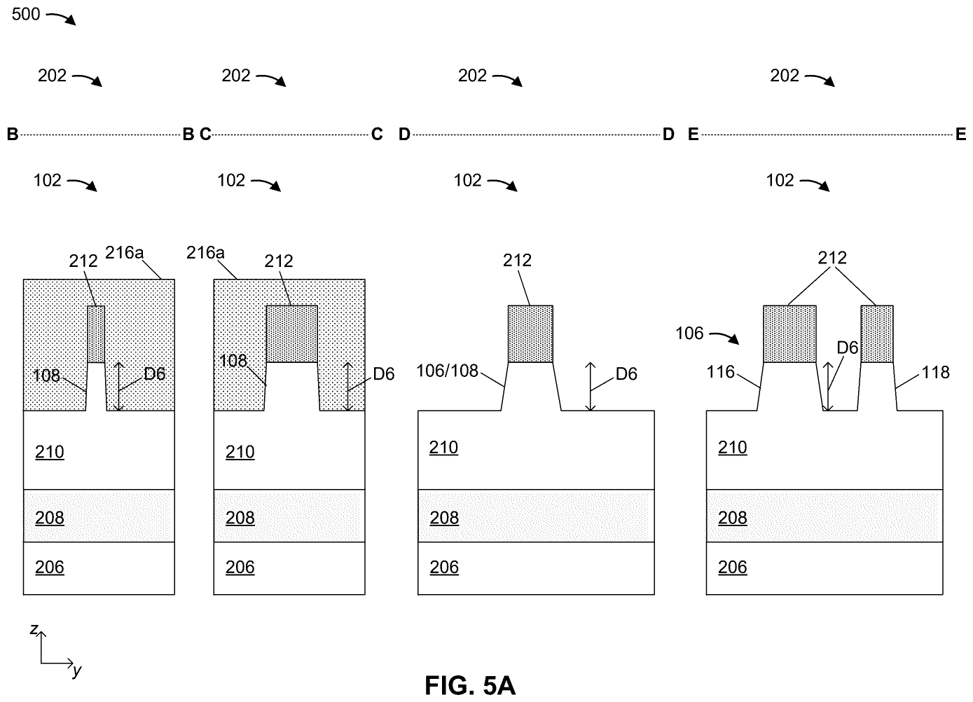

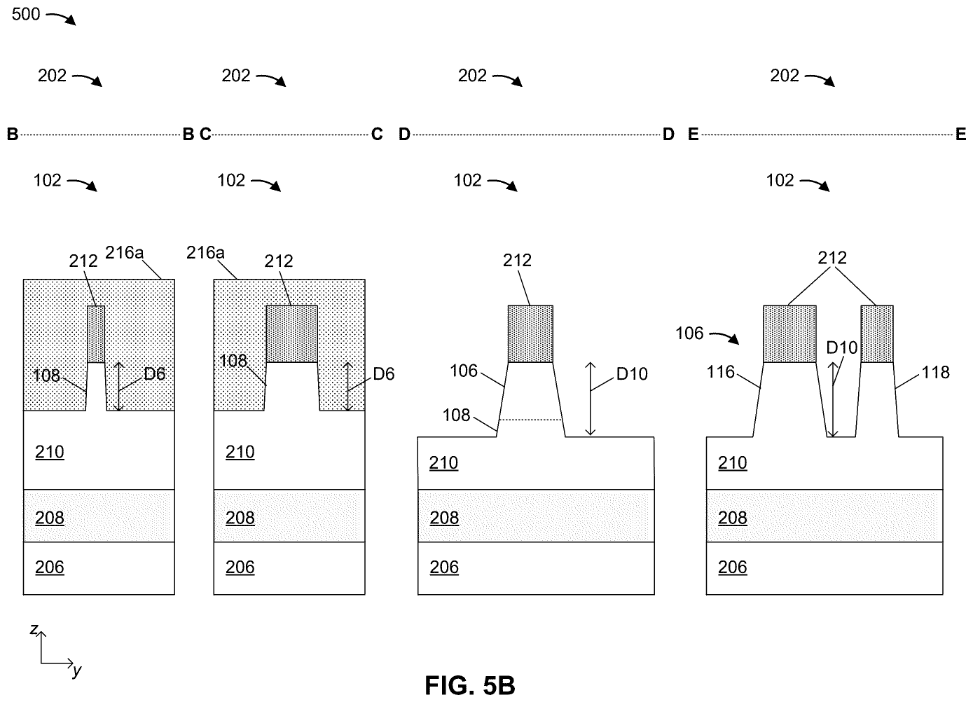

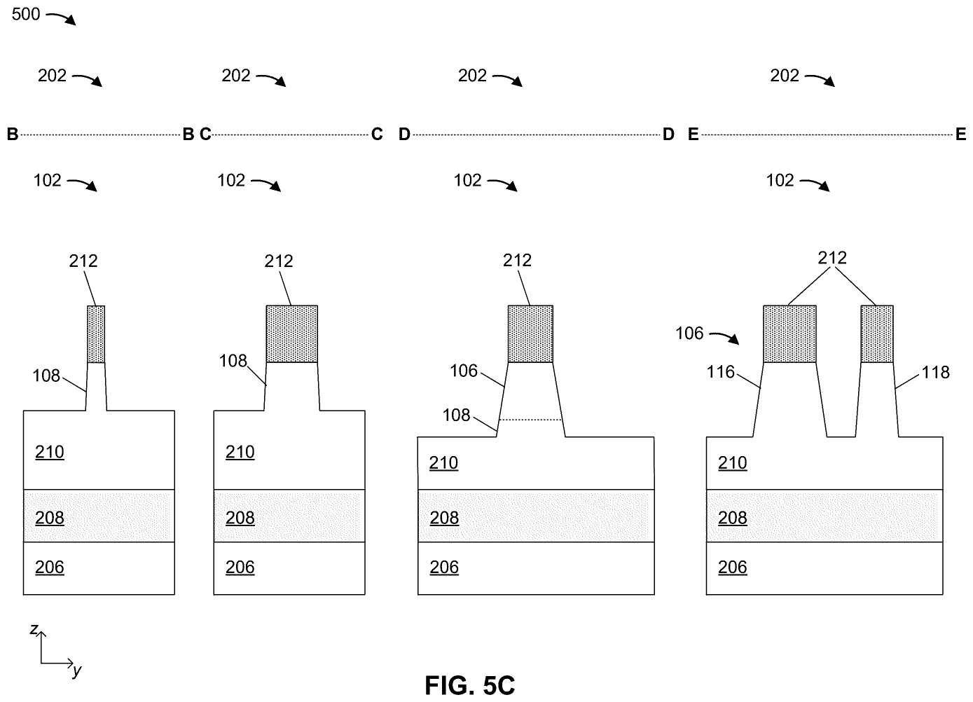

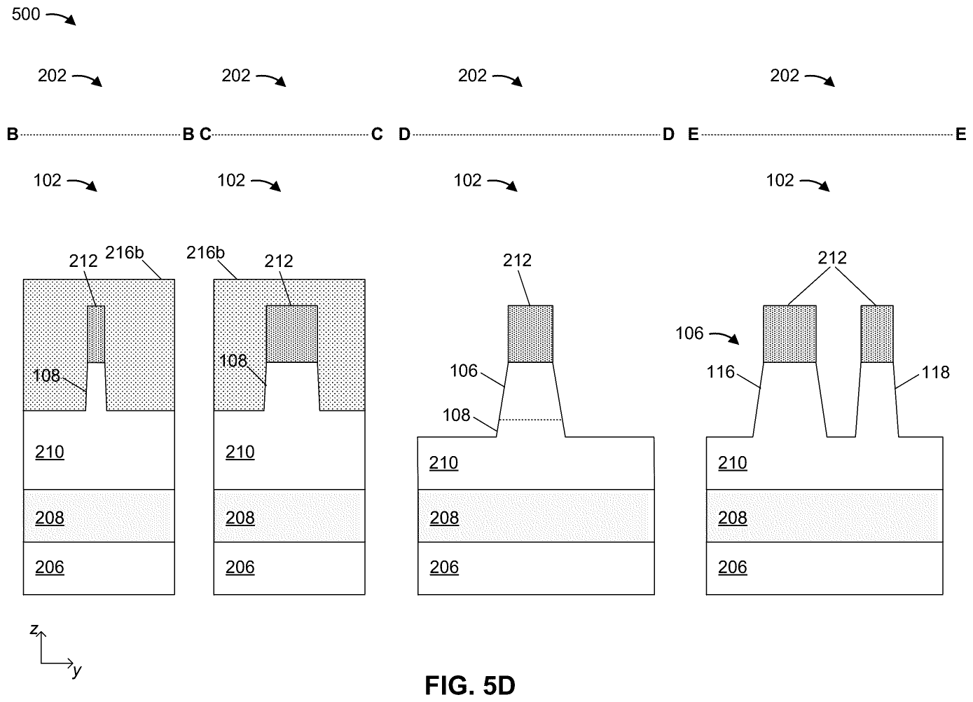

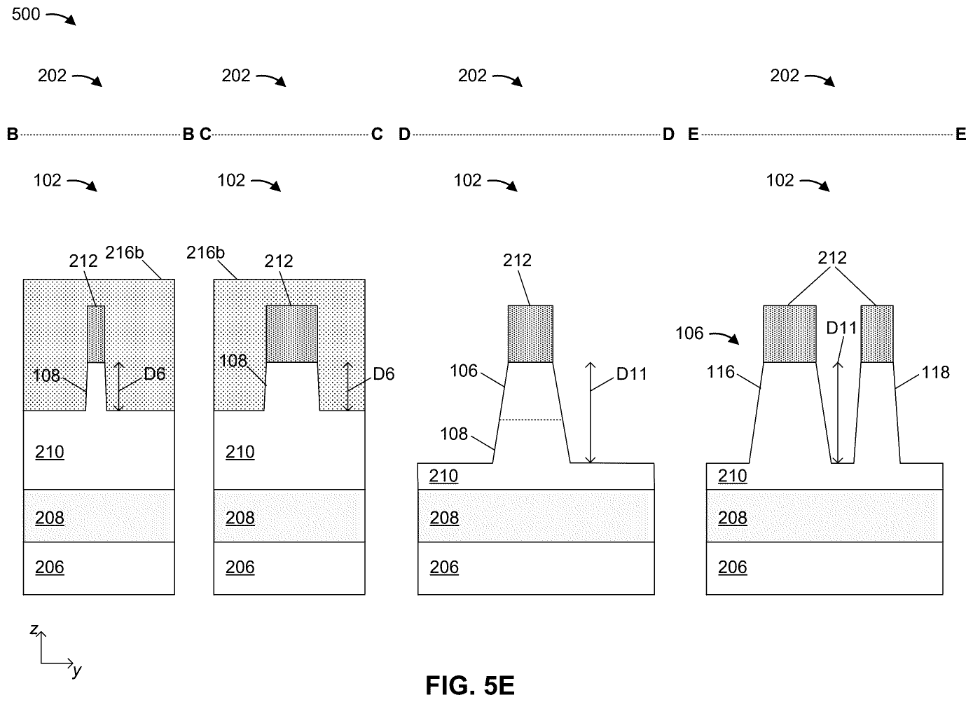

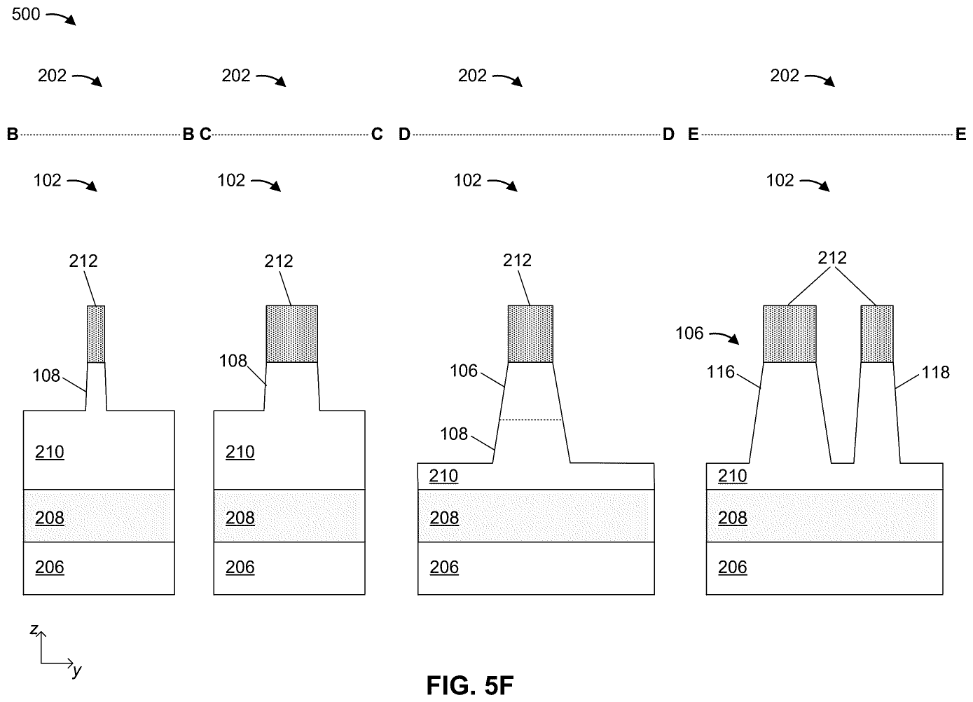

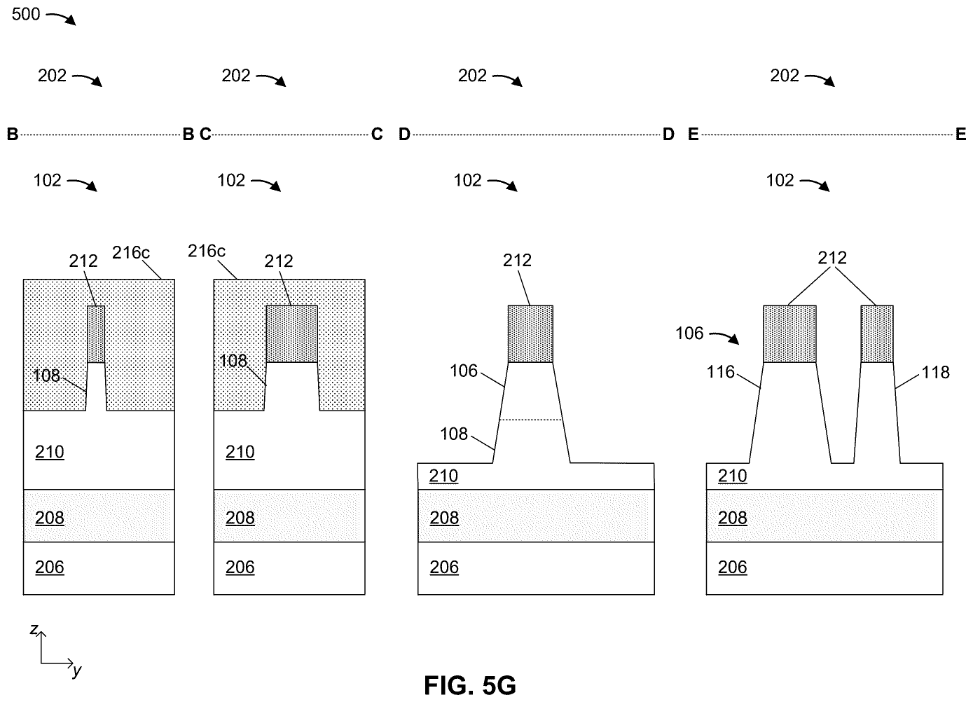

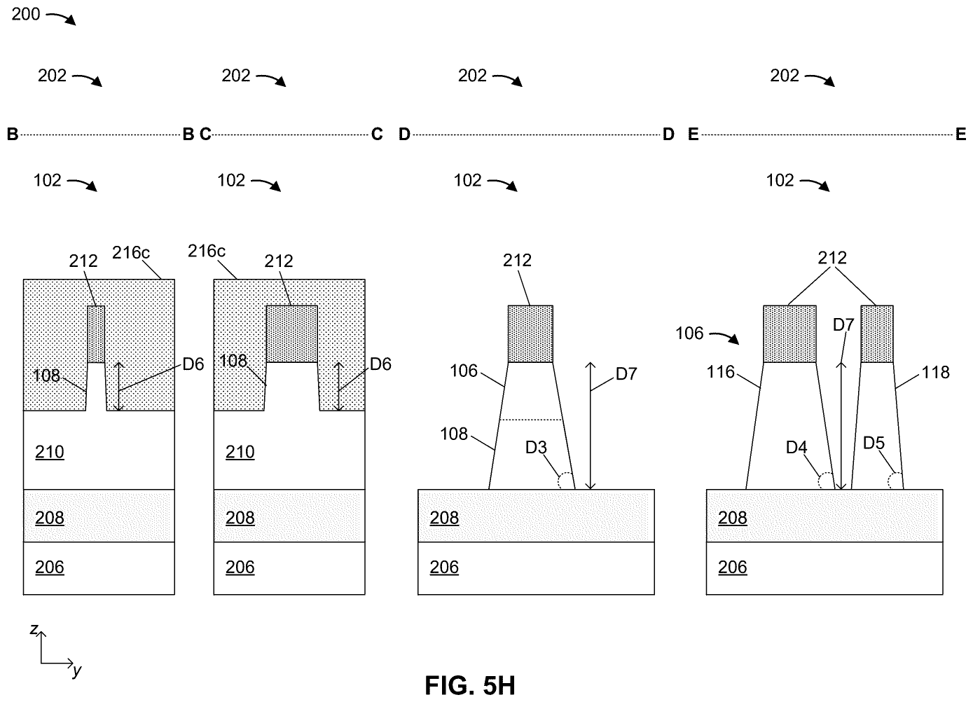

FIGS. 5A-5I are diagrams of an example implementation 500 of forming the example 100 of the photonic integrated circuit 102 described in connection with FIGS. 1A-1C. In some implementations, one or more of the semiconductor processing operations described in connection with FIGS. 5A-5I may be performed using one or more of the semiconductor processing tools, such as a deposition tool, an exposure tool, a developer tool, an etch tool, a planarization tool, a plating tool, an ion implantation tool, and/or a wafer/die transport tool, among other examples. One or more of FIGS. 5A-5I are illustrated from the cross-section views along lines B-B, C-C, D-D, and E-E in FIG. 1C.

The operations described in connection with FIGS. 5A-5I may be performed as an alternative process to the operations described in connection with FIGS. 2M-2R for etching the semiconductor layer 210 to form the PSR waveguide 106. In particular, the example implementation 500 illustrated in FIGS. 5A-5I includes performing a plurality of masking and etching cycles to incrementally etch the semiconductor layer 210 to form the PSR waveguide 106. The sequence of operations described in connection with FIGS. 5A-5I is an example and includes an example quantity of masking and etching cycles (e.g., 3 masking and etching cycles). However, other quantities of masking and etching cycles may be performed to incrementally etch the semiconductor layer 210 to form the PSR waveguide 106 using similar techniques as described in connection with FIGS. 5A-5I. Additionally and/or alternatively, the techniques described in connection with FIGS. 5A-5I may be performed to incrementally etch the semiconductor layer 210 to form the PSR waveguide 106 in the example 300 of the photonic integrated circuit 102 described in connection with FIGS. 3A-3C.

As shown in FIG. 5A, a first patterned masking layer 216a may be formed over the coupling waveguide 108, including the tapered section 136. In some implementations, the first patterned masking layer 216a is also formed over the tapered section 138 and/or the transition section 140 of the coupling waveguide 108.

As shown in FIG. 5B, the semiconductor layer 210 around the PSR waveguide 106 may be etched, while the first patterned masking layer 216a protects the coupling waveguide 108, to increase the thickness of the PSR waveguide 106 from the first thickness (dimension D6) to a first intermediate thickness (indicated in FIG. 5B as dimension D10).

As shown in FIG. 5C, a photoresist removal tool may be used to remove the remaining portions of the first patterned masking layer 216a using a chemical stripper, plasma ashing, and/or another technique. FIGS. 5A-5C may correspond to a first masking and etching cycle.

As shown in FIG. 5D, a second patterned masking layer 216b may be formed over the coupling waveguide 108, including the tapered section 136. In some implementations, the second patterned masking layer 216b is also formed over the tapered section 138 and/or the transition section 140 of the coupling waveguide 108.

As shown in FIG. 5E, the semiconductor layer 210 around the PSR waveguide 106 may be etched, while the second patterned masking layer 216b protects the coupling waveguide 108, to increase the thickness of the PSR waveguide 106 from the first intermediate thickness (dimension D10) to a second intermediate thickness (indicated in FIG. 5E as dimension D11).

As shown in FIG. 5F, a photoresist removal tool may be used to remove the remaining portions of the second patterned masking layer 216b using a chemical stripper, plasma ashing, and/or another technique. FIGS. 5D-5F may correspond to a second masking and etching cycle.

As shown in FIG. 5G, a third patterned masking layer 216c may be formed over the coupling waveguide 108, including the tapered section 136. In some implementations, the third patterned masking layer 216c is also formed over the tapered section 138 and/or the transition section 140 of the coupling waveguide 108.

As shown in FIG. 5H, the semiconductor layer 210 around the PSR waveguide 106 may be etched, while the second patterned masking layer 216b protects the coupling waveguide 108, to etch through the semiconductor layer 210, and to increase the thickness of the PSR waveguide 106 from the second intermediate thickness (dimension D11) to the second thickness (dimension D7).

As shown in FIG. 5I, a photoresist removal tool may be used to remove the remaining portions of the third patterned masking layer 216c using a chemical stripper, plasma ashing, and/or another technique. FIGS. 5G-5I may correspond to a third masking and etching cycle.

As indicated above, FIGS. 5A-5I are provided as an example. Other examples may differ from what is described with regard to FIGS. 5A-5I.

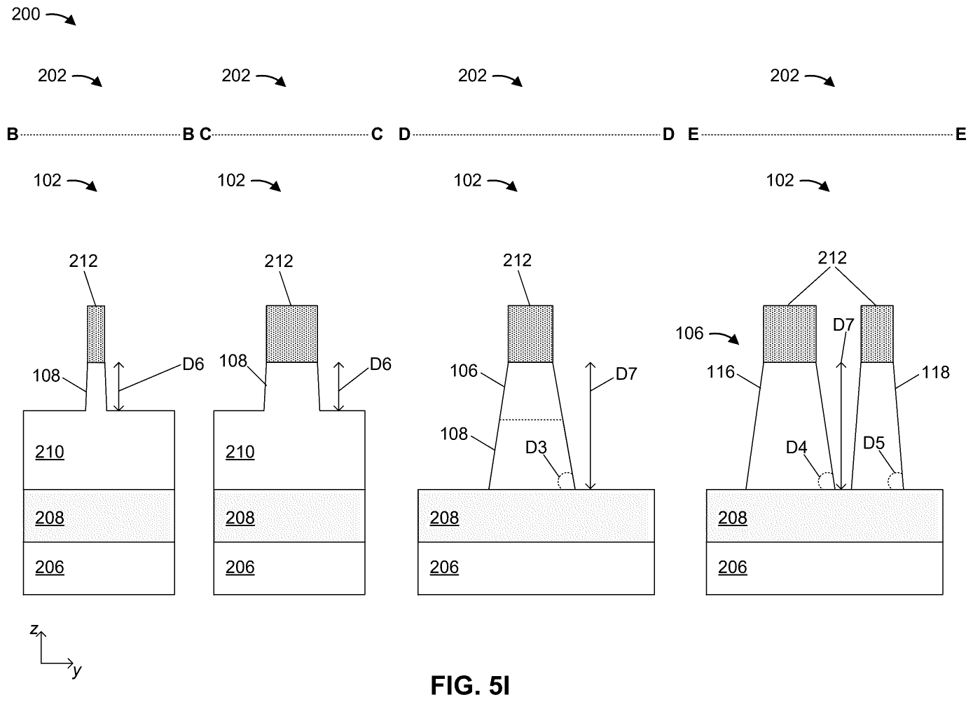

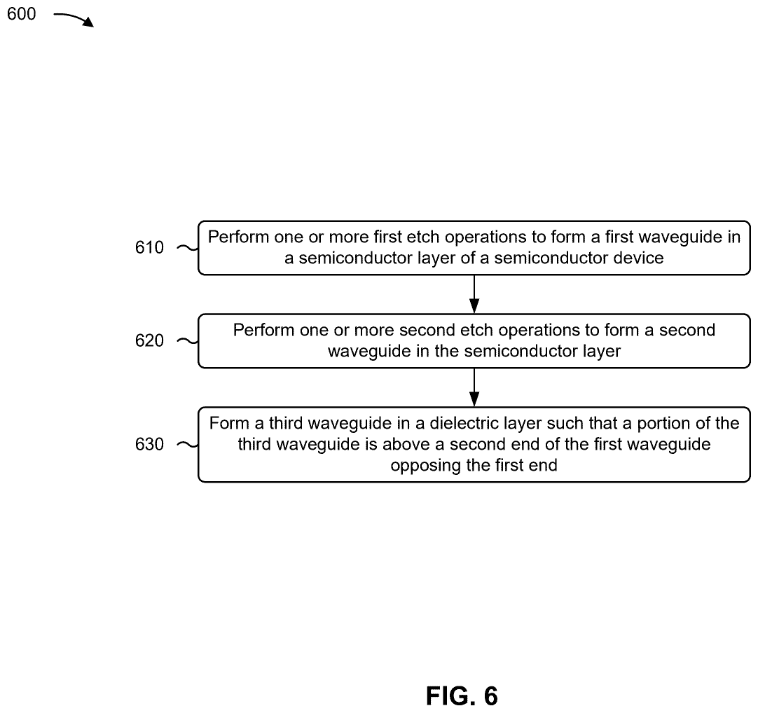

FIG. 6 is a flowchart of an example process 600 associated with forming a photonic integrated circuit described herein. In some implementations, one or more process blocks of FIG. 6 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 6, process 600 may include performing one or more first etch operations to form a first waveguide in a semiconductor layer of a semiconductor device (block 610). For example, one or more semiconductor processing tools may be used to perform one or more first etch operations to form a first waveguide (e.g., a coupling waveguide 108) in a semiconductor layer (e.g., a semiconductor layer 210) of a semiconductor device (e.g., a semiconductor device (202), as described herein.

As further shown in FIG. 6, process 600 may include performing one or more second etch operations to form a second waveguide in the semiconductor layer (block 620). For example, one or more semiconductor processing tools may be used to perform one or more second etch operations to form a second waveguide (e.g., a PSR waveguide 106) in the semiconductor layer, as described herein. In some implementations, a first end of the first waveguide is physically coupled to the second waveguide.

As further shown in FIG. 6, process 600 may include forming a third waveguide in a dielectric layer such that a portion of the third waveguide is above a second end of the first waveguide opposing the first end (block 630). For example, one or more semiconductor processing tools may be used to form a third waveguide (e.g., an edge coupler waveguide 104) in a dielectric layer (e.g., a dielectric layer 220) such that a portion (e.g., a tapered section 112) of the third waveguide is above a second end of the first waveguide opposing the first end, as described herein. In some implementations, a first angle (e.g., a dimension D1, a dimension D2), of a portion (e.g., a tapered section 136) of the first waveguide under the portion of the third waveguide, between a sidewall of the portion of the first waveguide and a bottom surface of the portion of the first waveguide, and a second angle (e.g., a dimension D4, a dimension D5) between a sidewall of the second waveguide and a bottom surface of the second waveguide, are different angles.

Process 600 may include additional implementations, such as any single implementation or any combination of implementations described below and/or in connection with one or more other processes described elsewhere herein.

In a first implementation, the first angle is greater than the second angle.

In a second implementation, alone or in combination with the first implementation, the first angle is included in a range of approximately 86 degrees to approximately 88 degrees, and the second angle is included in a range of approximately 80 degrees to approximately 85 degrees.

In a third implementation, alone or in combination with one or more of the first and second implementations, performing the one or more second etch operations includes performing the one or more second etch operations after performing the one or more first etch operations.

In a fourth implementation, alone or in combination with one or more of the first through third implementations, a third angle (e.g., a dimension D9), of another portion (e.g., a tapered section 138) of the first waveguide physically coupled to the second waveguide, between a sidewall of the other portion of the first waveguide and a bottom surface of the other portion of the first waveguide, and the second angle, are different angles.

In a fifth implementation, alone or in combination with one or more of the first through fourth implementations, the third angle is greater than the second angle.

In a sixth implementation, alone or in combination with one or more of the first through fifth implementations, process 600 includes performing a third etch operation, prior to performing the one or more first etch operations and the one or more second etch operations, to initiate formation of the first waveguide and the third waveguide in the semiconductor layer.

In a seventh implementation, alone or in combination with one or more of the first through sixth implementations, the performing the one or more first etch operations includes performing the one or more first etch operations using a first set of plasma-based etching parameters, performing the one or more second etch operations includes performing the one or more second etch operations using a second set of plasma-based etching, and the first set of plasma-based etching parameters are different from the second set of plasma-based etching parameters.

In an eighth implementation, alone or in combination with one or more of the first through seventh implementations, the first set of plasma-based etching parameters include a first plasma bias voltage, the second set of plasma-based etching parameters includes a second plasma bias voltage, and the first plasma bias voltage is greater than the second plasma bias voltage.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

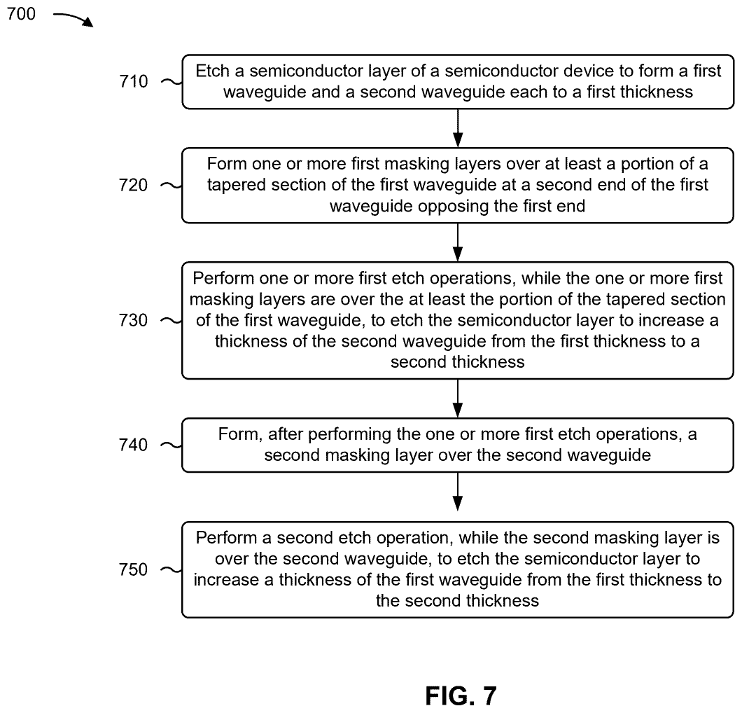

FIG. 7 is a flowchart of an example process 700 associated with forming photonic integrated circuit described herein. In some implementations, one or more process blocks of FIG. 7 are performed using one or more semiconductor processing tools, such as a deposition tool, an exposure tool, a developer tool, an etch tool, a planarization tool, an ion implantation tool, an annealing tool, a wafer/die transport tool, and/or another type of semiconductor processing tool.

As shown in FIG. 7, process 700 may include etching a semiconductor layer of a semiconductor device to form each of a first waveguide and a second waveguide to a first thickness (block 710). For example, one or more semiconductor processing tools may be used to etch a semiconductor layer of a semiconductor device to form a first waveguide (e.g., a coupling waveguide 108) and a second waveguide (e.g., a PSR waveguide 106) each to a first thickness (e.g., a dimension D6), as described herein. In some implementations, a first end (e.g., a tapered section 138) of the first waveguide is physically coupled to the second waveguide.

As further shown in FIG. 7, process 700 may include forming one or more first masking layers over at least a portion of a tapered section of the first waveguide at a second end of the first waveguide opposing the first end (block 720). For example, one or more semiconductor processing tools may be used to form one or more first masking layers (e.g., a patterned masking layer 216, a patterned masking layer 216a, a patterned masking layer 216b, a patterned masking layer 216c) over at least a portion of a tapered section (e.g., a tapered section 136) of the first waveguide at a second end of the first waveguide opposing the first end, as described herein.

As further shown in FIG. 7, process 700 may include performing one or more first etch operations, while the one or more first masking layers are over the at least the portion of the tapered section of the first waveguide, to etch the semiconductor layer to increase a thickness of the second waveguide from the first thickness to a second thickness (block 730). For example, one or more semiconductor processing tools may be used to perform one or more first etch operations, while the one or more first masking layers are over the at least the portion of the tapered section of the first waveguide, to etch the semiconductor layer to increase a thickness of the second waveguide from the first thickness to a second thickness (e.g., a dimension D7), as described herein.

As further shown in FIG. 7, process 700 may include forming, after performing the one or more first etch operations, a second masking layer over the second waveguide (block 740). For example, one or more semiconductor processing tools may be used to form, after performing the one or more first etch operations, a second masking layer (e.g., a patterned masking layer 218) over the second waveguide, as described herein.

As further shown in FIG. 7, process 700 may include performing a second etch operation, while the second masking layer is over the second waveguide, to etch the semiconductor layer to increase a thickness of the first waveguide from the first thickness to the second thickness (block 750). For example, one or more semiconductor processing tools may be used to perform a second etch operation, while the second masking layer is over the second waveguide, to etch the semiconductor layer to increase a thickness of the first waveguide from the first thickness to the second thickness, as described herein.

Process 700 may include additional implementations, such as any single implementation or any combination of implementations described below and/or in connection with one or more other processes described elsewhere herein.

In a first implementation, process 700 includes removing the one or more first masking layers prior to forming the second masking layer.

In a second implementation, alone or in combination with the first implementation, a first angle (e.g., a dimension D1, a dimension D2) between a sidewall of the tapered section of the first waveguide and a bottom surface of the tapered section of the first waveguide, is greater than a second angle (e.g., a dimension D4, a dimension D5) between a sidewall of the second waveguide and a bottom surface of the second waveguide.

In a third implementation, alone or in combination with one or more of the first and second implementations, forming the one or more first masking layers and performing the one or more first etch operations include forming a first photoresist layer (e.g., a patterned masking layer 216a), of the one or more first masking layers, over the at least the portion of the tapered section of the first waveguide, performing, while the first photoresist layer is over the at least the portion of the tapered section of the first waveguide, a first trench etch operation of the one or more first etch operations to etch the semiconductor layer to increase the thickness of the second waveguide, forming a second photoresist layer (e.g., a patterned masking layer 216b, a patterned masking layer 216c), of the one or more first masking layers, over the at least the portion of the tapered section of the first waveguide, and performing, while the second photoresist layer is over the at least the portion of the tapered section of the first waveguide, a second trench etch operation of the one or more first etch operations to etch the semiconductor layer to increase the thickness of the second waveguide.

In a fourth implementation, alone or in combination with one or more of the first through third implementations, process 700 includes removing the first photoresist layer prior to forming the second photoresist layer.

In a fifth implementation, alone or in combination with one or more of the first through fourth implementations, process 700 includes forming a third photoresist layer (e.g., a patterned masking layer 216c), of the one or more first masking layers, over the at least the portion of the tapered section of the first waveguide, and performing, while the third photoresist layer is over the at least the portion of the tapered section of the first waveguide, a third trench etch operation of the one or more first etch operations to etch the semiconductor layer to increase the thickness of the second waveguide.

Although FIG. 7 shows example blocks of process 700, in some implementations, process 700 includes additional blocks, fewer blocks, different blocks, or differently arranged blocks than those depicted in FIG. 7. Additionally, or alternatively, two or more of the blocks of process 700 may be performed in parallel.

In this way, a photonic integrated circuit of a semiconductor device is manufactured to include a PSR waveguide, an edge coupler waveguide, and a coupling waveguide that optically couples the PSR waveguide and the edge coupler waveguide. The PSR waveguide and the coupling waveguide are manufactured to have different sidewall angles. In particular, the PSR waveguide may be manufactured to have a lesser sidewall angle than the coupling waveguide, and the coupling waveguide may be manufactured to have a greater sidewall angle than the PSR waveguide. The lesser sidewall angle of the sidewalls of the PSR waveguide results in the PSR waveguide having a greater amount of sidewall taper, which enables a high gap-filling performance to be achieved when forming a dielectric layer over the PSR waveguide. The greater sidewall angle of the sidewalls of the coupling waveguide results in the coupling waveguide having a lesser amount of sidewall taper (e.g., more vertical sidewalls), which provides a greater amount of surface area at the top of the coupling waveguide for increased coupling efficiency and reduced optical signal loss for coupling of input optical signals from the edge coupler waveguide to the coupling waveguide.

As described in greater detail above, some implementations described herein provide a method. The method includes performing one or more first etch operations to form a first waveguide in a semiconductor layer of a semiconductor device. The method includes performing one or more second etch operations to form a second waveguide in the semiconductor layer, where a first end of the first waveguide is physically coupled to the second waveguide. The method includes forming a third waveguide in a dielectric layer such that a portion of the third waveguide is above a second end of the first waveguide opposing the first end, where a first angle, of a portion of the first waveguide under the portion of the third waveguide, between a sidewall of the portion of the first waveguide and a bottom surface of the portion of the first waveguide, and a second angle between a sidewall of the second waveguide and a bottom surface of the second waveguide, are different angles.

As described in greater detail above, some implementations described herein provide a method. The method includes etching a semiconductor layer of a semiconductor device to form each of a first waveguide and a second waveguide to a first thickness, where a first end of the first waveguide is physically coupled to the second waveguide. The method includes forming one or more first masking layers over at least a portion of a tapered section of the first waveguide at a second end of the first waveguide opposing the first end. The method includes performing one or more first etch operations, while the one or more first masking layers are over the at least the portion of the tapered section of the first waveguide, to etch the semiconductor layer to increase a thickness of the second waveguide from the first thickness to a second thickness. The method includes forming, after performing the one or more first etch operations, a second masking layer over the second waveguide. The method includes performing a second etch operation, while the second masking layer is over the second waveguide, to etch the semiconductor layer to increase a thickness of the first waveguide from the first thickness to the second thickness.

As described in greater detail above, some implementations described herein provide a semiconductor device. The semiconductor device includes a first waveguide. The semiconductor device includes a second waveguide physically coupled to a first end of the first waveguide. The semiconductor device includes a third waveguide above a second end of the first waveguide opposing the first end, where a first sidewall angle of the first waveguide at the second end is greater than a second sidewall angle between of a portion of the second waveguide that is not in physical contact with first waveguide.

The terms “approximately” and “substantially” can indicate a value of a given quantity that varies within 5% of the value (e.g., +1%, +2%, +3%, +4%, +5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
performing one or more first etch operations to form a first waveguide in a semiconductor layer of a semiconductor device;
performing one or more second etch operations to form a second waveguide in the semiconductor layer,
wherein a first end of the first waveguide is physically coupled to the second waveguide; and
forming a third waveguide in a dielectric layer such that a portion of the third waveguide is above a second end of the first waveguide opposing the first end,
wherein a portion of the first waveguide under the portion of the third waveguide has a first angle between a sidewall of the portion of the first waveguide and a bottom surface of the portion of the first waveguide,
wherein the second waveguide has a second angle between a sidewall of the second waveguide and a bottom surface of the second waveguide, and
wherein the first angle and the second angle are different angles.

2. The method of claim 1, wherein the first angle is greater than the second angle.

3. The method of claim 1, wherein the first angle is included in a range of approximately 86 degrees to approximately 88 degrees.

4. The method of claim 1, wherein a third angle, of another portion of the first waveguide physically coupled to the second waveguide, between a sidewall of the other portion of the first waveguide and a bottom surface of the other portion of the first waveguide, and the second angle, are different angles.

5. The method of claim 1, wherein the performing the one or more first etch operations comprises:
performing the one or more first etch operations using a first set of plasma-based etching parameters; and
wherein the performing the one or more second etch operations comprises:
performing the one or more second etch operations using a second set of plasma-based etching,
wherein the first set of plasma-based etching parameters are different from the second set of plasma-based etching parameters.

6. The method of claim 1, wherein the first set of plasma-based etching parameters comprises a first plasma bias voltage;
wherein the second set of plasma-based etching parameters comprises a second plasma bias voltage; and
wherein the first plasma bias voltage is greater than the second plasma bias voltage.

7. The method of claim 1, further comprising:
performing a third etch operation, prior to performing the one or more first etch operations and the one or more second etch operations, to initiate formation of the first waveguide and the third waveguide in the semiconductor layer.

8. A method, comprising:
etching a semiconductor layer of a semiconductor device to form a first waveguide and a second waveguide each to a first thickness,
wherein a first end of the first waveguide is physically coupled to the second waveguide;
forming one or more first masking layers over at least a portion of a tapered section of the first waveguide at a second end of the second waveguide opposing the first end;
performing one or more first etch operations, while the one or more first masking layers are over the at least the portion of the tapered section of the first waveguide, to etch the semiconductor layer to increase a thickness of the second waveguide from the first thickness to a second thickness;
forming, after performing the one or more first etch operations, a second masking layer over the second waveguide; and
performing a second etch operation, while the second masking layer is over the second waveguide, to etch the semiconductor layer to increase a thickness of the first waveguide from the first thickness to the second thickness.

9. The method of claim 8, further comprising:
removing the one or more first masking layers prior to forming the second masking layer.

10. The method of claim 8, wherein a first angle between a sidewall of the tapered section of the first waveguide and a bottom surface of the tapered section of the first waveguide, is greater than a second angle between a sidewall of the second waveguide and a bottom surface of the second waveguide.

11. The method of claim 8, wherein forming the one or more first masking layers and performing the one or more first etch operations comprise:
forming a first photoresist layer, of the one or more first masking layers, over the at least the portion of the tapered section of the first waveguide;
performing, while the first photoresist layer is over the at least the portion of the tapered section of the first waveguide, a first trench etch operation of the one or more first etch operations to etch the semiconductor layer to increase the thickness of the second waveguide;
forming a second photoresist layer, of the one or more first masking layers, over the at least the portion of the tapered section of the first waveguide; and
performing, while the second photoresist layer is over the at least the portion of the tapered section of the first waveguide, a second trench etch operation of the one or more first etch operations to etch the semiconductor layer to increase the thickness of the second waveguide.

12. The method of claim 11, further comprising:
removing the first photoresist layer prior to forming the second photoresist layer.

13. The method of claim 11, further comprising:
forming a third photoresist layer, of the one or more first masking layers, over the at least the portion of the tapered section of the first waveguide; and
performing, while the third photoresist layer is over the at least the portion of the tapered section of the first waveguide, a third trench etch operation of the one or more first etch operations to etch the semiconductor layer to increase the thickness of the second waveguide.

14. A semiconductor device, comprising:
a first waveguide;
a second waveguide physically coupled to a first end of the first waveguide; and
a third waveguide above a second end of the first waveguide opposing the first end,
wherein a first sidewall angle of the first waveguide at the second end is greater than a second sidewall angle between of a portion of the second waveguide that is spaced apart from the first waveguide.

15. The semiconductor device of claim 14, wherein the first waveguide comprises a first semiconductor waveguide;
wherein the second waveguide comprises a second semiconductor waveguide; and
wherein the third waveguide comprises a dielectric waveguide.

16. The semiconductor device of claim 14, wherein the first sidewall angle is included in a range of approximately 86 degrees to approximately 88 degrees.

17. The semiconductor device of claim 14, wherein the first waveguide comprises:
a first tapered section at the second end of the first waveguide,
wherein the first tapered section is under a portion of the third waveguide; and
a second tapered section at the first end of the first waveguide,
wherein the second tapered section is physically coupled with the second waveguide.

18. The semiconductor device of claim 17, wherein the first tapered section has the first sidewall angle; and
wherein the second tapered section has a third sidewall angle that is approximately equal to the second sidewall angle.

19. The semiconductor device of claim 17, wherein the first tapered section has the first sidewall angle; and
wherein the second tapered section has a third sidewall angle that is approximately equal to the first sidewall angle.

20. The semiconductor device of claim 15, wherein the first waveguide comprises a coupling waveguide;
wherein the second waveguide comprises a polarization splitter and rotator (PSR) waveguide; and
wherein the third waveguide comprises an edge coupler waveguide.
